(19) United States
(12) Patent Application Publication
(10) Pub. No.: US 2015/0292939 A1
(43) Pub. Date: Oct. 15, 2015

(54) LIGHT-GUIDING DEVICE AND DISPLAY APPARATUS

(71) Applicant: SHARP KABUSHIKI KAISHA, Osaka (JP)

(72) Inventors: Akira Saitoh, Osaka-shi (JP); Takaharu Shimizu, Osaka-shi (JP); Yohei Kudo, Osaka-shi (JP); Yuhsuke Ebata, Osaka-shi (JP); Ryuji Hanao, Osaka-shi (JP); Hideaki Nishizawa, Osaka-shi (JP); Ryoji Yokoi, Osaka-shi (JP)

(73) Assignee: SHARP KABUSHIKI KAISHA, Osaka-shi, Osaka (JP)

(21) Appl. No.: 14/442,778

(22) PCT Filed: Nov. 15, 2013
(86) PCT No.: PCT/JP2013/080858

§ 371 Date: May 14, 2015

(30) Foreign Application Priority Data
Nov. 15, 2012 (JP) 2012-251164
Nov. 14, 2013 (JP) 2013-235610

(51) Int. Cl. G01J 1/04; G02B 6/26; G02B 6/10; G01J 1/42

(52) U.S. Cl. CPC G01J 1/0407; G01J 1/4204; G02B 6/262; G02B 6/102

(57) ABSTRACT

Difference between light intake quantities just from a front and from an upper direction is reduced in an illuminance sensor. A light-guiding member includes a light-guiding member base part, a compound light-guiding part and an infrared light receiving light-guiding part. Side surface parts each extending backward are formed at right and left ends of the light-guiding member base part. The compound light-guiding part includes a front square column part extending frontward from the light-guiding member base part, a back square column part extending backward therefrom, and a round column part extending frontward from the front square column part. A plurality of slits are formed in the light-guiding member base part such that boundaries of base portions of the front square column part and the back square column part communicate with each other.

### TECHNICAL FIELD

The present invention relates to a light-guiding device that guides light to an illuminance sensor, and a display apparatus that has such a light-guiding device and an illuminance sensor.

### BACKGROUND ART

A thin display apparatus represented by a liquid crystal television has a function of automatically controlling luminance according to surrounding brightness for the purpose of power saving in many cases. In order to realize the function, an illuminance sensor is arranged in a lower area of a display. Specifically, a backlight is controlled according to detected illuminance of the illuminance sensor which is arranged on a substrate.

FIG. 1 is a view schematically showing a cross-sectional structure of a typical liquid crystal television 510 which includes an illuminance sensor 540. As illustrated, a transparent light-guiding member 550 is arranged on a lower side of a front surface of the liquid crystal television 510 (right side in the figure), and external light is illuminated to a light receiving element 542 of the inside illuminance sensor 540. Then, screen luminance is controlled according to illuminance of the light.

FIG. 2 are perspective views showing the detailed light-guiding member 550 which is comparatively typically used, in which FIG. 2A is a front perspective view, FIG. 2B is a back perspective view and FIG. 2C is a cross-sectional view. The light-guiding member 550 is integrally molded from a transparent resin, and has a round column light-guiding part 560 for guiding to the illuminance sensor 540 and an infrared light receiving light-guiding part 559 that guides an infrared signal of a remote controller or the like to an infrared sensor arranged side by side. Here, a front round column part 561 extends forward from a plate-shaped light-guiding member base part 552 and a back round column part 562 extends backward therefrom. Moreover, positioning opening parts 558 for positioning and fixing are formed so as to put the round column light-guiding part 560 therebetween.

Detection accuracy of the illuminance sensor 540 is important for performing control of screen luminance appropriately, and various technologies have been proposed. For example, there is a technology that an illuminance sensor (optical sensor) is provided inside an image display apparatus and by devising a light-guiding lens that guides ambient light to the optical sensor, light from a nearby light source is illuminated to the optical sensor (for example, refer to PATENT LITERATURE 1). Specifically, sawtooth-shape slope faces are provided on one end face of the light-guiding lens, which is directed outward from the image display apparatus. Further, angles of the slope faces are differentiated in accordance with height direction positions, so that light having an incident angle in a predetermined range is guided to the optical sensor at each position.

### CITATION LIST

### Patent Literature

PATENT LITERATURE 1: Japanese Laid-Open Patent Publication No. 2011-223238

### SUMMARY OF INVENTION

### Technical Problem

Meanwhile, as a requirement for power saving is increased, fine control is being required more than before. That is, it is necessary to perform control finely according to external light conditions (brightness). The light receiving element of the illuminance sensor is arranged below a screen frame as described above, and needs to work effectively to front light LA and upper light LB (light in frontward oblique 45-degree direction) as shown in FIG. 1 with respect to a sensor light entering window in actual operation. However, when actually measuring these two types of light by an illuminance meter 599, intake quantities of external light are different in some cases depending on a type of a display apparatus. As a result thereof, a design for appropriately adjusting luminance sometimes becomes difficult, and a technology for countermeasure has been required. That is, a technology by which a difference between light intake quantities just from a front and from an upper direction is reduced has been needed.

Here, a problem when the round column light-guiding part 560 is used is shown in FIG. 3. That is, light from an upper side, which is incident from an incident surface 560a of the round column light-guiding part 560, is emitted from a backward emitting surface 560b while being reflected inside, and illuminated to the light receiving element. An inventor of the present invention found that since a reflection surface inside of which light is reflected was a curved surface, a final emitting direction was hard to be controlled as a result of simulation. That is, it was revealed that the inside reflection on the reflection surface has characteristics like irregular reflection, so that the emitted light was difficult to be condensed to the light receiving element efficiently, and luminous flux density in the light receiving element was decreased. Thus, it was recognized that a technology for guiding the incident light to the light receiving element efficiently should be introduced.

In recent years, a new technology has been needed because of a situation where introducing of the technology disclosed in PATENT LITERATURE 1 is not enough.

The present invention has been made in view of circumstances as described above, and aims to provide a technology by which the aforementioned problem is solved.

### Solution to Problem

The present invention provides a light-guiding device that guides light to an illuminance sensor of a display apparatus, including a light-guiding part of a column shape, in which one surface of the light-guiding part is a light incident surface on which the light is incident and one surface facing thereto is a light emitting surface from which the light is emitted, a first side surface which is one of surfaces orthogonal to the light incident surface and a second side surface facing the first side surface are in parallel, and the first side surface is disposed to be horizontal in a state of being attached to the display apparatus.

The present invention provides a light-guiding device that guides light to an illuminance sensor of a display apparatus, including a light-guiding part of a column shape, in which one surface of the light-guiding part is a light incident surface on which the light is incident and one surface facing thereto is a light emitting surface from which the light is emitted, in a first side surface which is one of surfaces orthogonal to the light incident surface and a second side surface facing the first side surface, two straight lines corresponding to the first side surface and the second side surface are in parallel when the light-guiding part is cut along a width direction, and the straight line corresponding to the first side surface is horizontal in a state of being attached to the display apparatus.

Moreover, a support part that supports the light-guiding part in a lateral direction, and slits formed on a boundary portion between the support part and the light-guiding part may be included.

Moreover, a light-guiding part support part that supports the light-guiding part in a lateral direction may be included, and a member with a low refractive index than that of the light-guiding part may be provided between the light-guiding part support part and the light-guiding part on a surface of the light-guiding part in the lateral direction.

Moreover, an incident part of a round column shape which is formed integrally with the light-guiding part may be provided on an incident side of the light-guiding part of the column shape.

A display apparatus of the present invention includes the aforementioned light-guiding device and an illuminance sensor which acquires external light by the light-guiding device.

### Advantageous Effect of Invention

According to the present invention, it is possible to realize a technology by which a difference between light intake quantities just from a front and from an upper direction is reduced in an illuminance sensor.

### BRIEF DESCRIPTION OF DRAWINGS

FIG. 1 is a view showing situation of light intake of an illuminance sensor of a liquid crystal television.

FIG. 2 are views showing a light-guiding member according to a background art.

FIG. 3 are views for explaining a problem when a round column light-guiding part is used according to the background art.

FIG. 4 are views showing a square column light-guiding member having a rectangular cross-sectional surface according to an embodiment.

FIG. 5 are views showing a compound light-guiding member according to the embodiment.

FIG. 6 are views explaining a problem when a square column light-guiding part is introduced in actual equipment and countermeasure therefor according to the embodiment.

FIG. 7 is a view showing a liquid crystal television according to the embodiment.

FIG. 8 is a cross-sectional view of a portion where an illuminance sensor module is arranged according to the embodiment.

FIG. 9 are perspective views of the light-guiding member according to the embodiment.

FIG. 10 are views of six sides of the light-guiding member according to the embodiment.

FIG. 11 is a view showing a cross-sectional shape of the light-guiding member according to the embodiment.

FIG. 12 is a table showing a result of comparison of light propagation characteristics of light-guiding members of a conventional type and a type of the present embodiment by simulation according to the embodiment.

FIG. 13 is a graph showing characteristics of the conventional type and the type of the present embodiment as to a result of the simulation of FIG. 12 in a comparable manner according to the embodiment.

FIG. 14 are views showing light path characteristics of the conventional type and the type of the present embodiment shown in the graph of FIG. 12 in a comparable manner according to the embodiment.

FIG. 15 is a functional block diagram of the liquid crystal television according to the embodiment.

FIG. 16 are views showing cross-sectional shapes of light-guiding members according to a second embodiment.

FIG. 17 are views showing a light-guiding part and a compound light-guiding part which have square pyramid shapes according to a third embodiment.

FIG. 18 is a view showing a cross-sectional shape of a light-guiding member according to a fourth embodiment.

FIG. 19 are views showing cross-sectional shapes of light-guiding members according to a fifth embodiment.

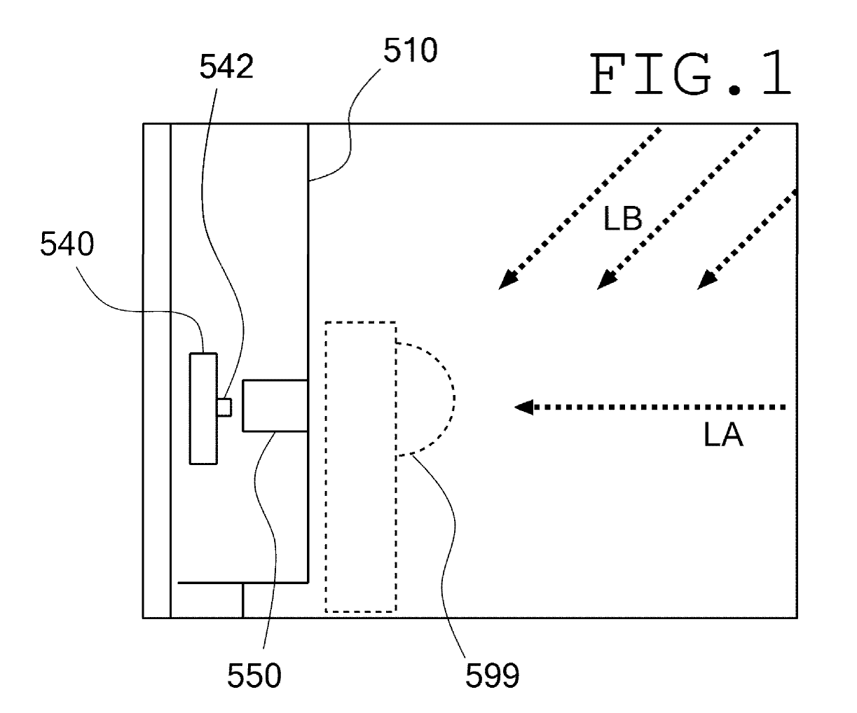

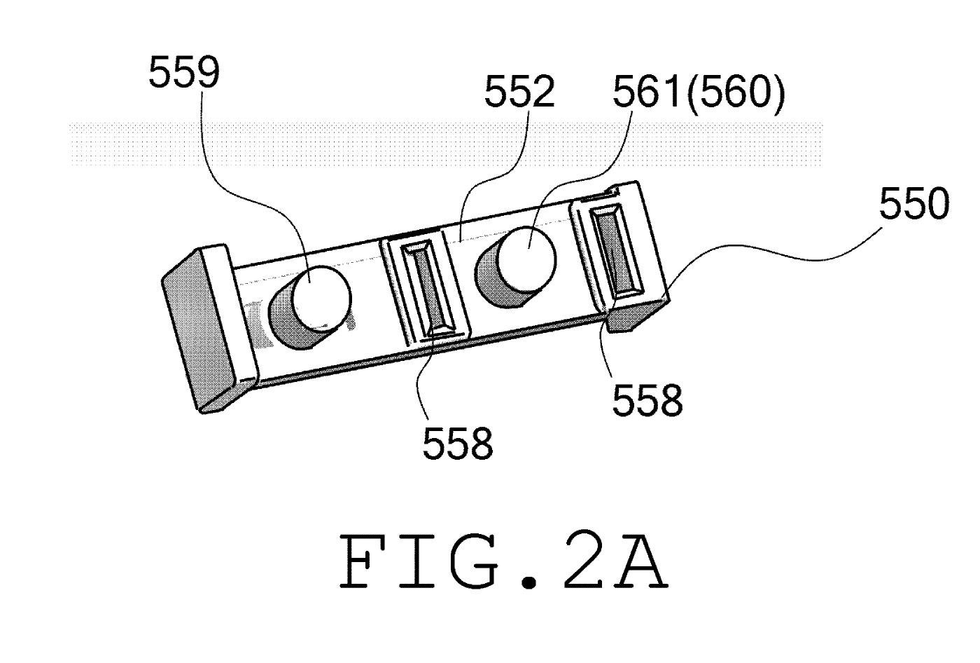

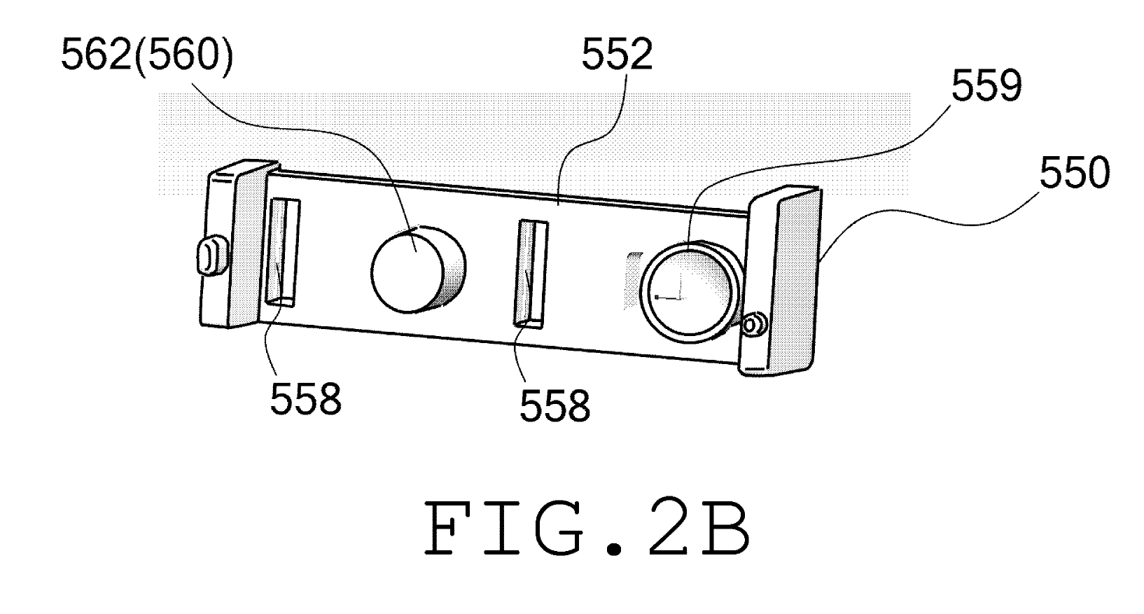

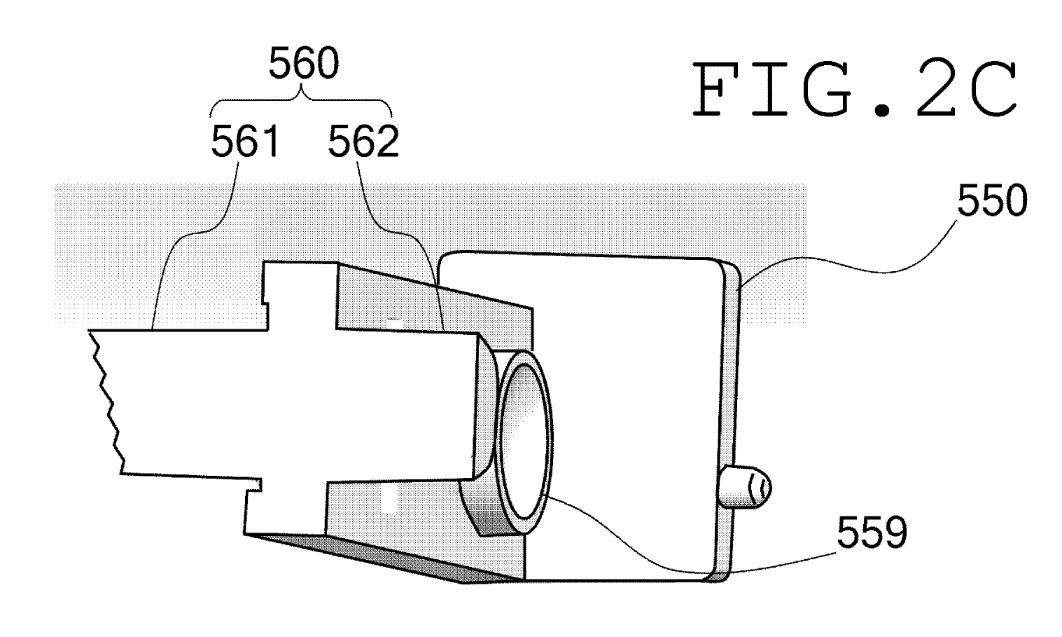

### DESCRIPTION OF EMBODIMENTS

Next, description will be given specifically for modes for carrying out the present invention (hereinafter, simply referred to as “embodiments”) with reference to drawings.

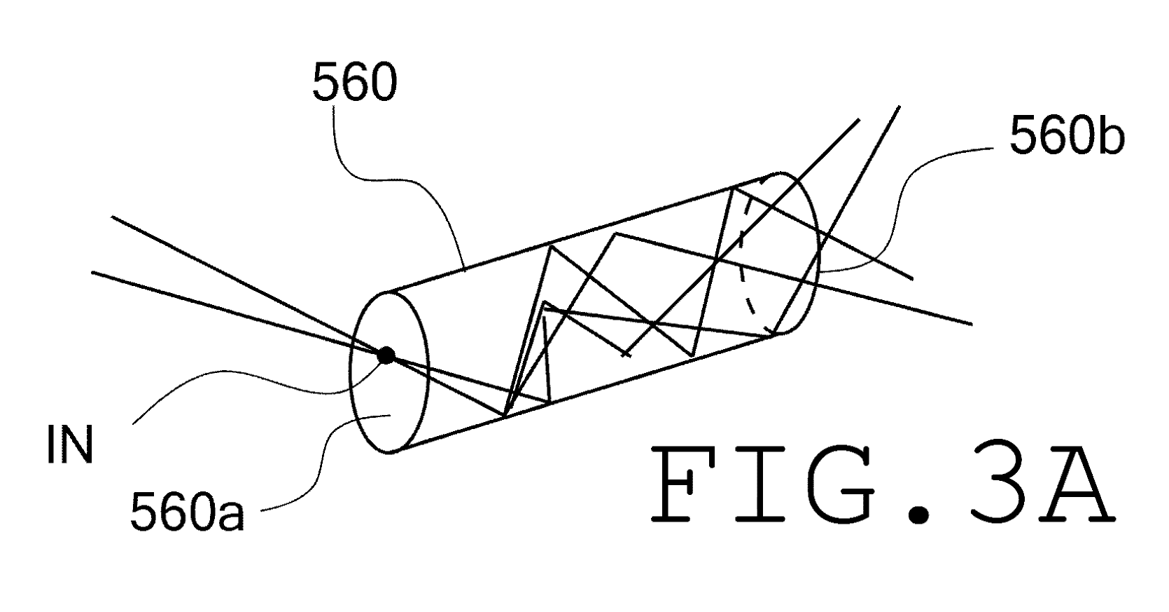

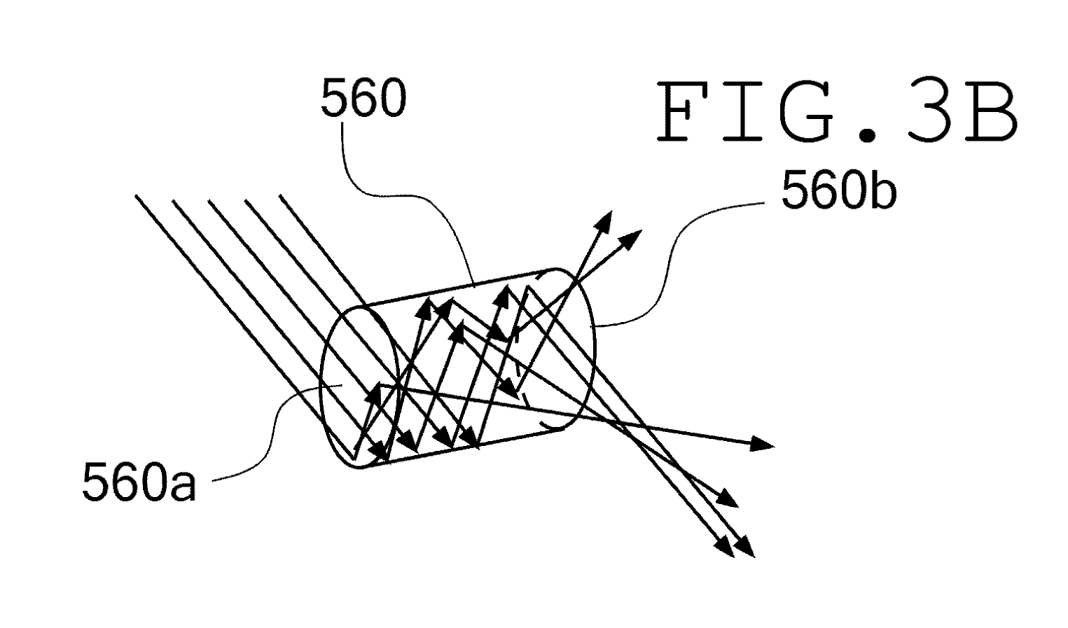

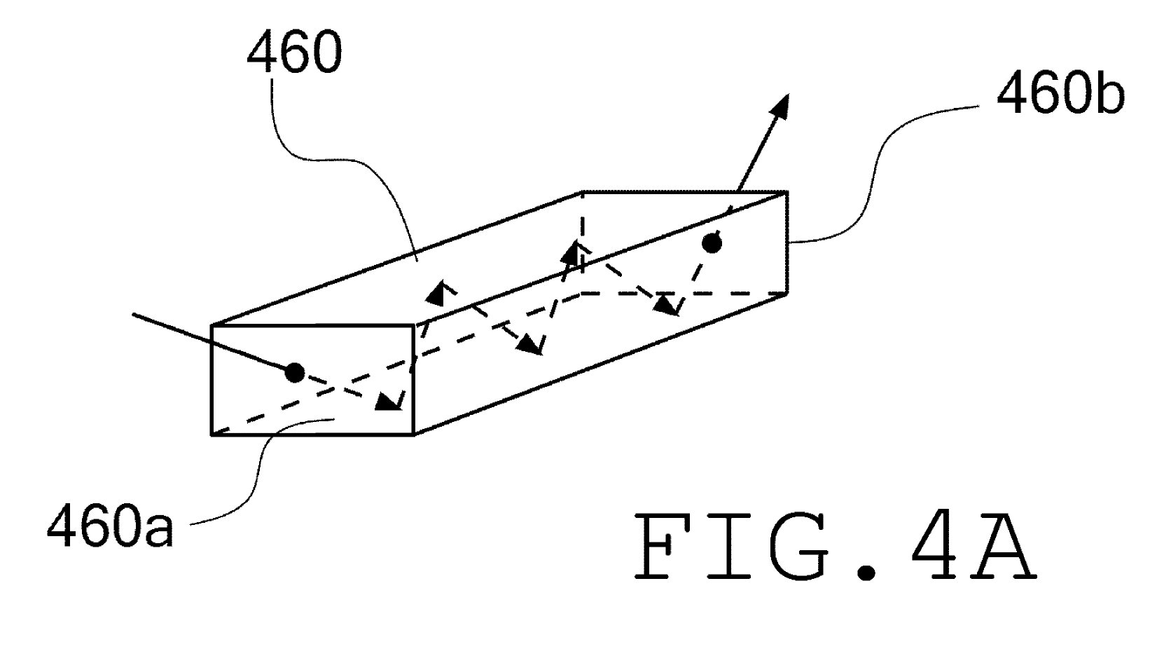

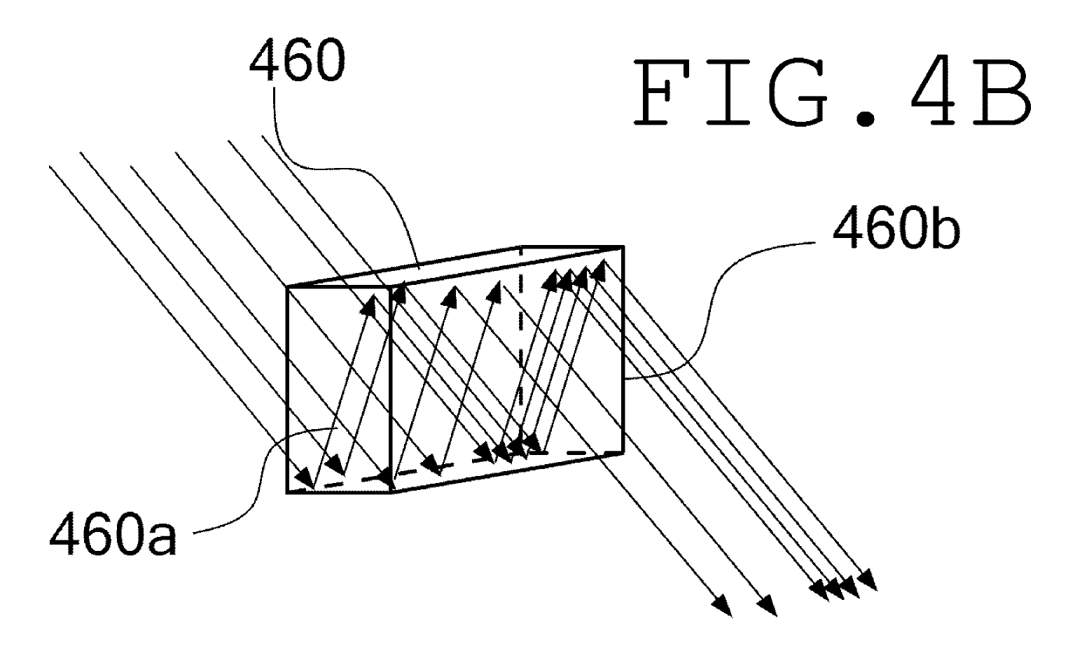

First, description will be given for knowledge obtained by examination of a problem of the round column light-guiding part 560 explained in FIG. 3 by using FIGS. 4 to 6.

The reflection surface of the round column light-guiding part 560 of FIG. 3 is the curved surface. Therefore, a square column light-guiding member 460 is used as light-guiding means as shown in FIG. 4. In the square column light-guiding member 460, a cross-sectional surface is a rectangle (including square) and an upper surface and a lower surface of the cross-sectional surface are horizontal. That is, the upper and lower facing surfaces are horizontal. As a result thereof, light incident from an incident surface 460a which is one end surface in a longitudinal direction is subjected to so-called regular reflection on the upper plane and the lower plane. Thus, it becomes easy to control an emitting direction of light emitted from an emitting surface 460b which is the other end surface in the longitudinal direction. That is, it becomes easy to perform control so that most of light (light flux) incident from upward in an oblique 45-degree direction finally advances in a direction of a light receiving element of an illuminance sensor. Note that, the end surface in the longitudinal direction is one which is typically referred to as a bottom surface in a square column. Further, the upper plane and the lower plane which are surfaces in a lateral direction are parts of surfaces which are typically referred to as side surfaces in the square column.

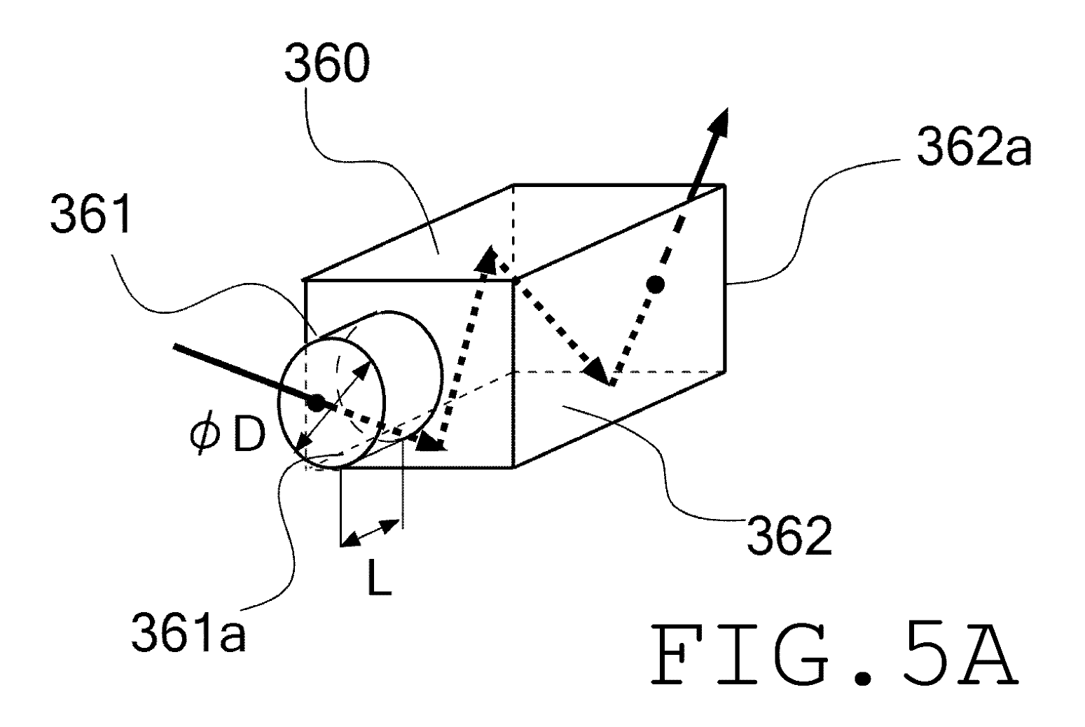

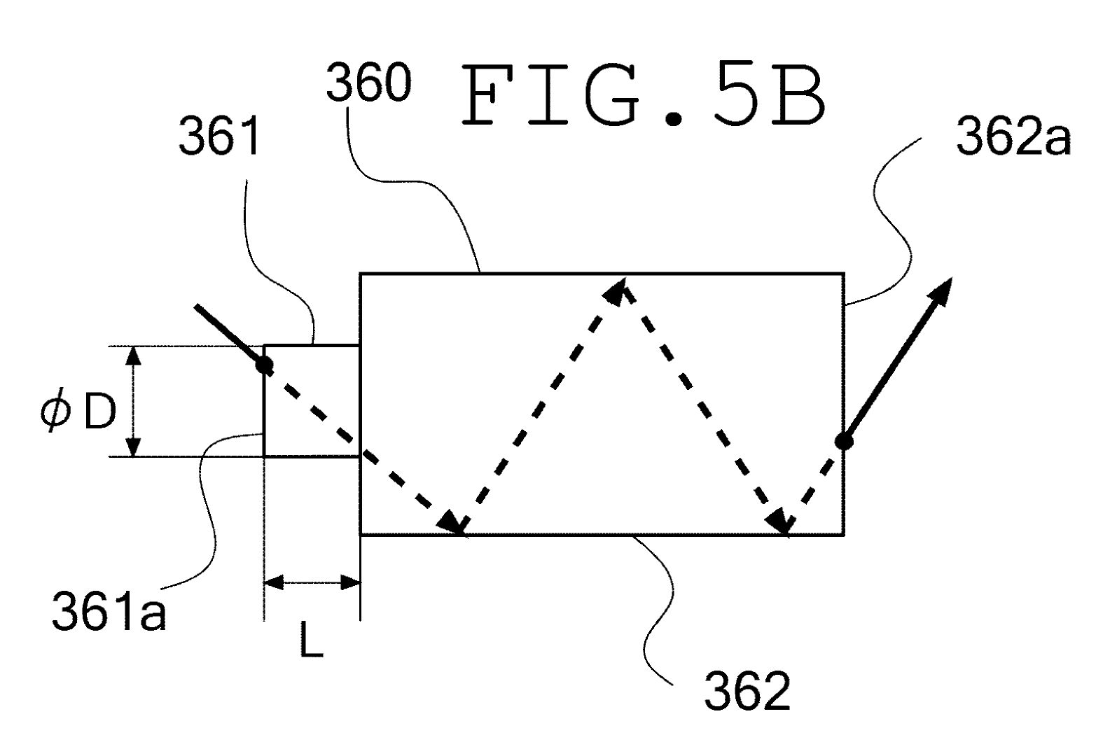

FIG. 5 show a compound light-guiding member 360 which has a light receiving part as a round column shape. This compound light-guiding member 360 integrally includes a square column part 362 having a rectangular cross-sectional surface and a round column part 361 having a round cross-sectional surface provided on a light receiving side. As descried in FIG. 4, from a viewpoint of reflection of light which is taken inside, a configuration that so-called regular reflection is performed on the upper plane and the lower plane is preferable. From a viewpoint of design, however, the round column part 361 is on the light receiving side. Note that, a relation between a diameter D and a length L of the round column part 361 is L<D/2, and the length L is preferably made small. With a size having such a relation, it is possible to cause most of the light incident from upward in the oblique 45-degree direction to reflect on the lower surface of the square column part 362.

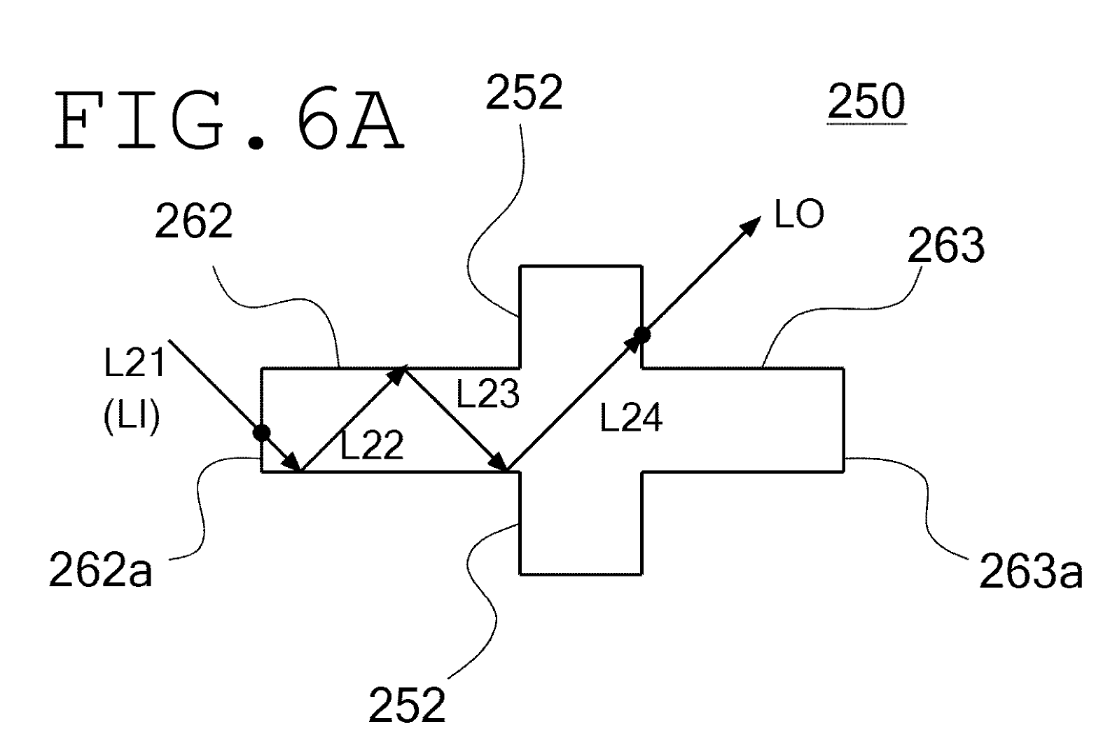

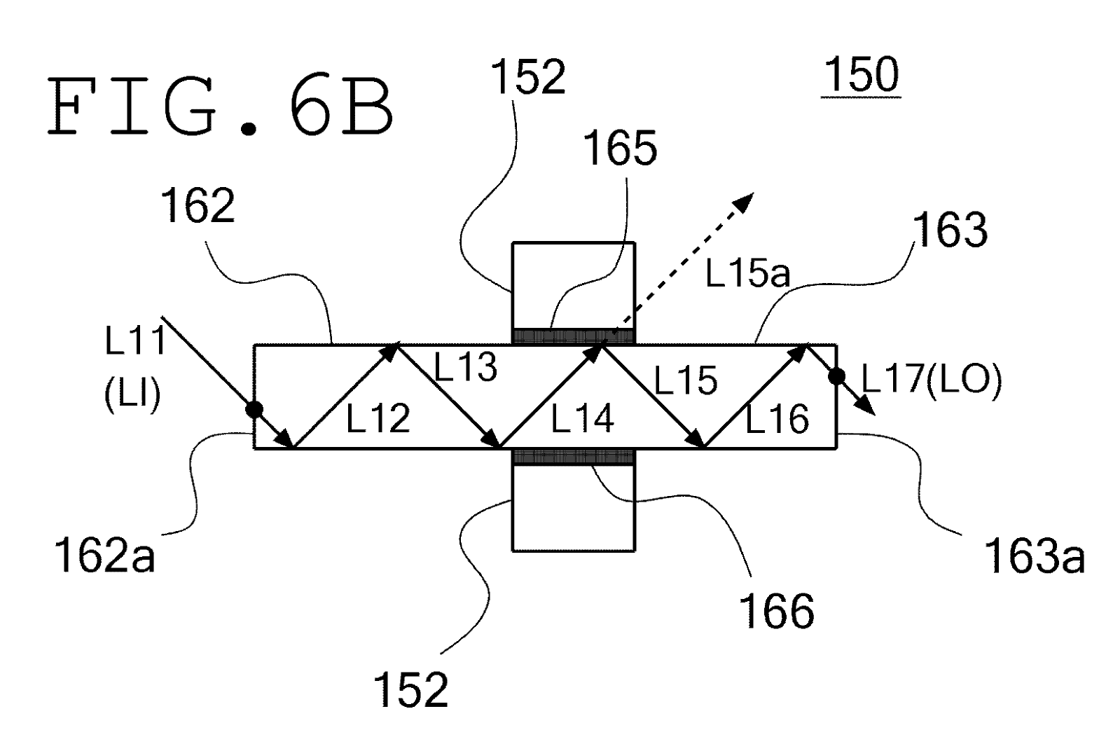

FIG. 6 are views explaining a problem when the square column light-guiding part is introduced in actual equipment and countermeasure therefor. FIG. 6A is for explaining a problem when no countermeasure is taken, and there is a same problem also in a conventional round column light-guiding part. Such a light-guiding member 250 integrally includes a plate-shaped light-guiding member base part 252, and a front square column part 262 and a back square column part 263 which are formed in front and back so as to hold it therebetween.

Since the light-guiding member base part 252, and the front square column part 262 and the back square column part 263 are molded integrally from a same material, light L21 incident from an incident surface 262a is reflected inside successively to be reflection light L22 and L23, which does not reach the back square column part 263 when passing through a thickness portion of the light-guiding member base part 252, and is emitted from an emitting side of the light-guiding member base part 252 in some cases (emitted light LO illustrated in the figures). A light quantity reaching a light receiving element is reduced just for a portion of the light.

Thus, as shown in a light-guiding member 150 of FIG. 6B, an upper-side slit part 165 and a lower-side slit part 166 which communicate back and forth are formed on a boundary portion between a light-guiding member base part 152, and a front square column part 162 and a back square column part 163. As a result thereof, light L11 incident from an incident surface 162a is firstly reflected on an upper surface and a lower surface of the front square column part 262 (reflection light L12, L13 in the figure) before reaching an area of the light-guiding member base part 152. Then, light L14 which has reached the area of the light-guiding member base part 152 is reflected on the boundary portion with the upper-side slight part 165 (reflection light L15). That is, light L15a advancing to an emitting side of the light-guiding member base part 152 is not generated. As a result thereof, reflection light L15 and L16 reaches the back square column part 163 and substantially all the light is emitted from an emitting surface 163a (emitted light L17).

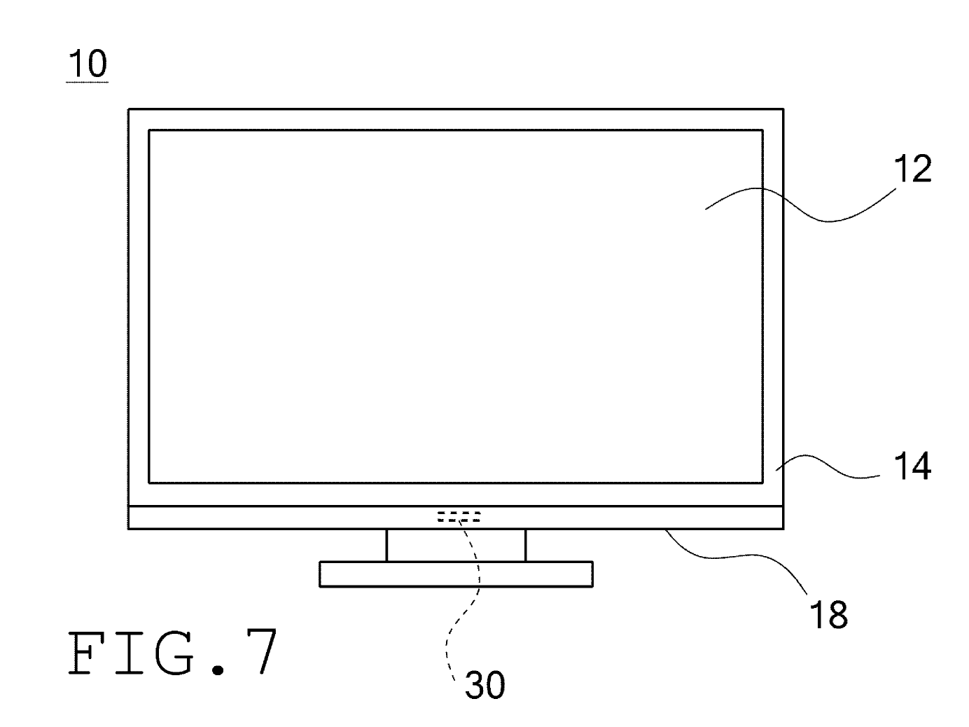

Description will be given for a liquid crystal television 10 to which the aforementioned technology is applied with reference to FIG. 7 to FIG. 11.

FIG. 7 is a view schematically showing the liquid crystal television 10 according to the present embodiment. Note that, though the liquid crystal television 10 is exemplified as a thin display apparatus in the present embodiment, it is also possible to apply to an organic EL display apparatus (organic EL television) or the like. As illustrated, the liquid crystal television 10 includes a frame-shaped front cabinet 14 that covers a display panel 12 and an ornamental cabinet 18 that is provided in a lower side thereof. An illuminance sensor module 30 is provided at a center portion of the ornamental cabinet 18.

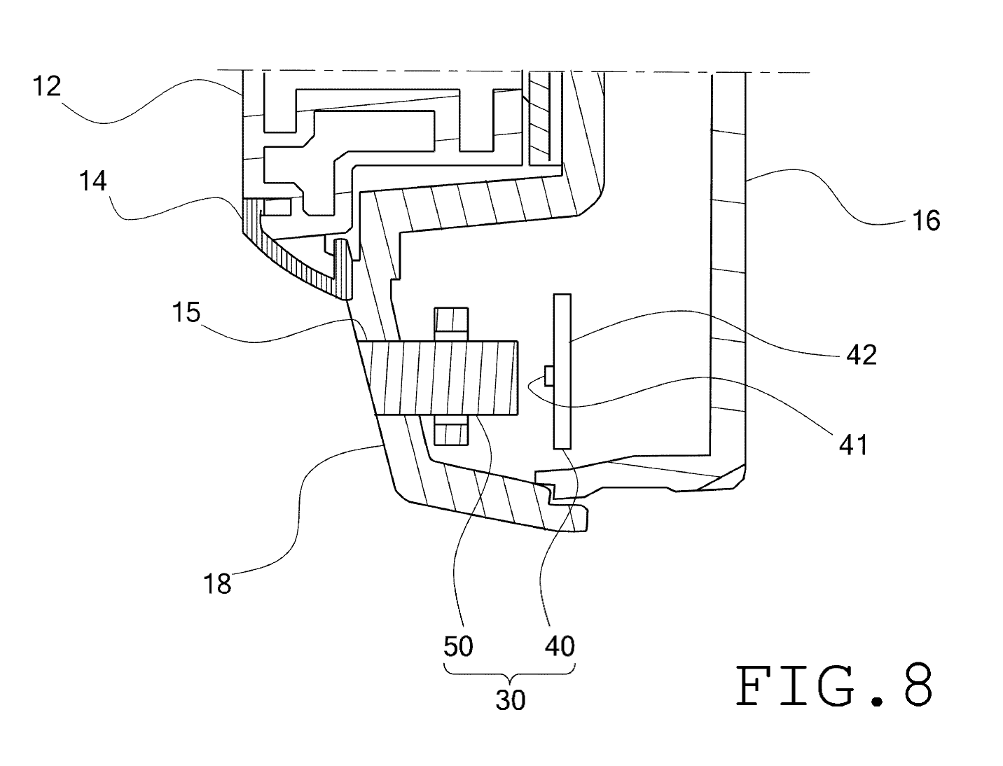

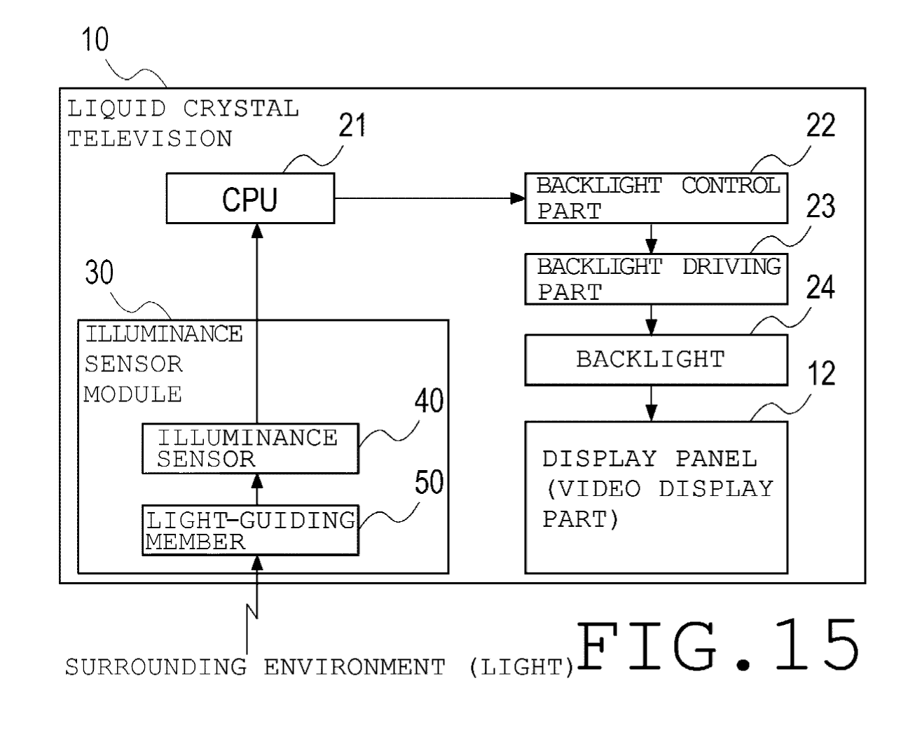

FIG. 8 is a cross-sectional view of a portion where the illuminance sensor module 30 is arranged. The illuminance sensor module 30 is arranged in a space which is formed by a back surface of the display panel 12 (ornamental cabinet 18) and a rear cabinet 16, and includes a light-guiding member 50 and an illuminance sensor 40. The illuminance sensor 40 includes a substrate 42 and a light receiving element 41, and acquires light introduced from outside at the light-guiding member 50. FIG. 15 is a functional block diagram of the liquid crystal television 10, and is shown by mainly focusing on backlight control using the illuminance sensor module 30. The liquid crystal television 10 performs control of brightness of a screen according to light (illuminance) of a surrounding environment which is acquired by using the illuminance sensor module 30. Specifically, a backlight 24 is arranged on a back surface side of the display panel 12 which is a video display part. A CPU (Central Processing Unit) 21 which is a predetermined control part acquires illuminance detected by the illuminance sensor 40 of the illuminance sensor module 30. The backlight control part 22 controls a backlight driving part 23 to control light emission of the backlight 24 based on the detected illuminance acquired by the CPU 12.

Further, as illustrated in the figure, a communication port 15 is formed in the ornamental cabinet 18, and a part of the light-guiding member 50 (round column part 61 described below) is attached to the communication port 15.

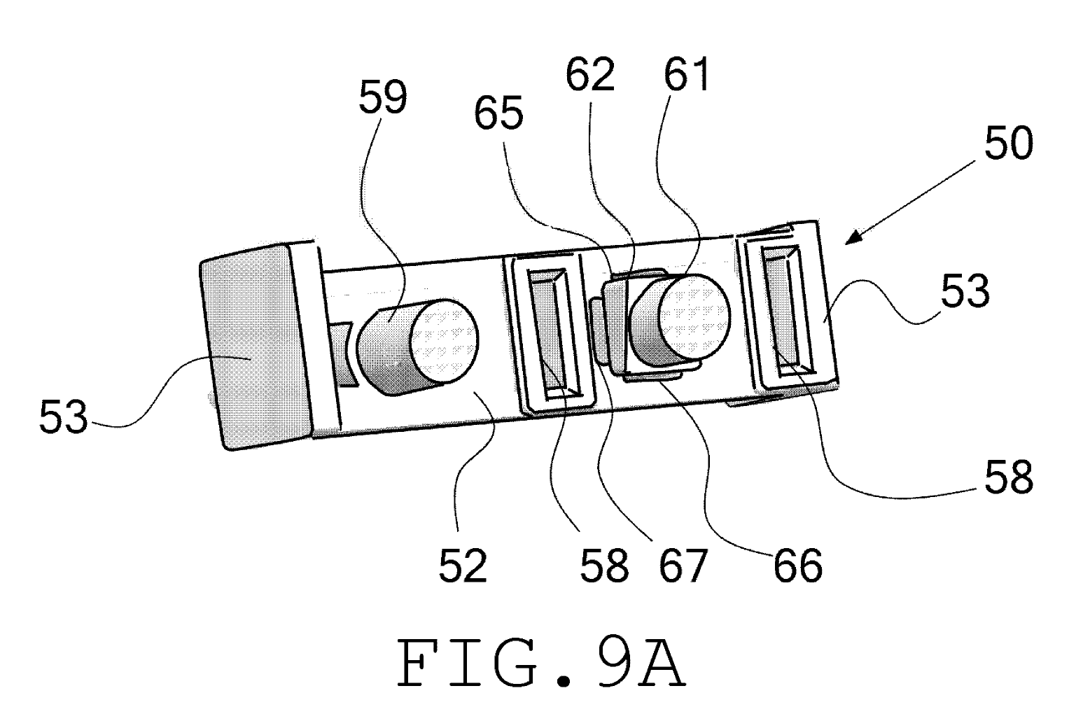

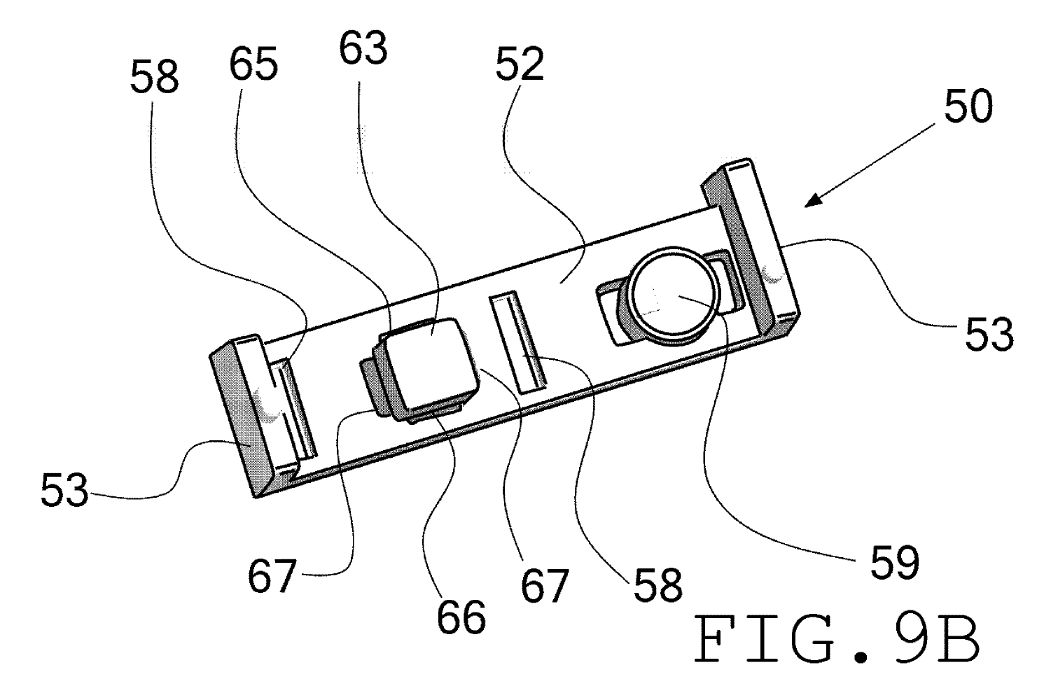

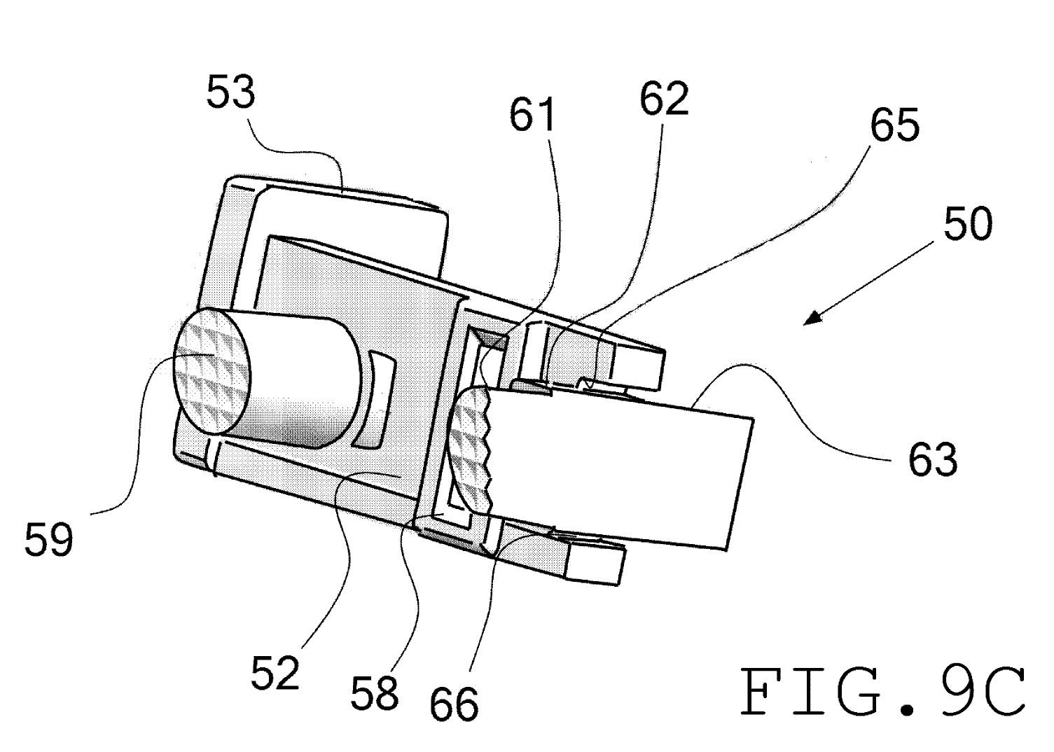

FIG. 9 are perspective views of the light-guiding member 50, in which FIG. 9A is a perspective view of a front side, FIG. 9B is a perspective view of a back side, and FIG. 9C is a partially cross-sectional perspective view.

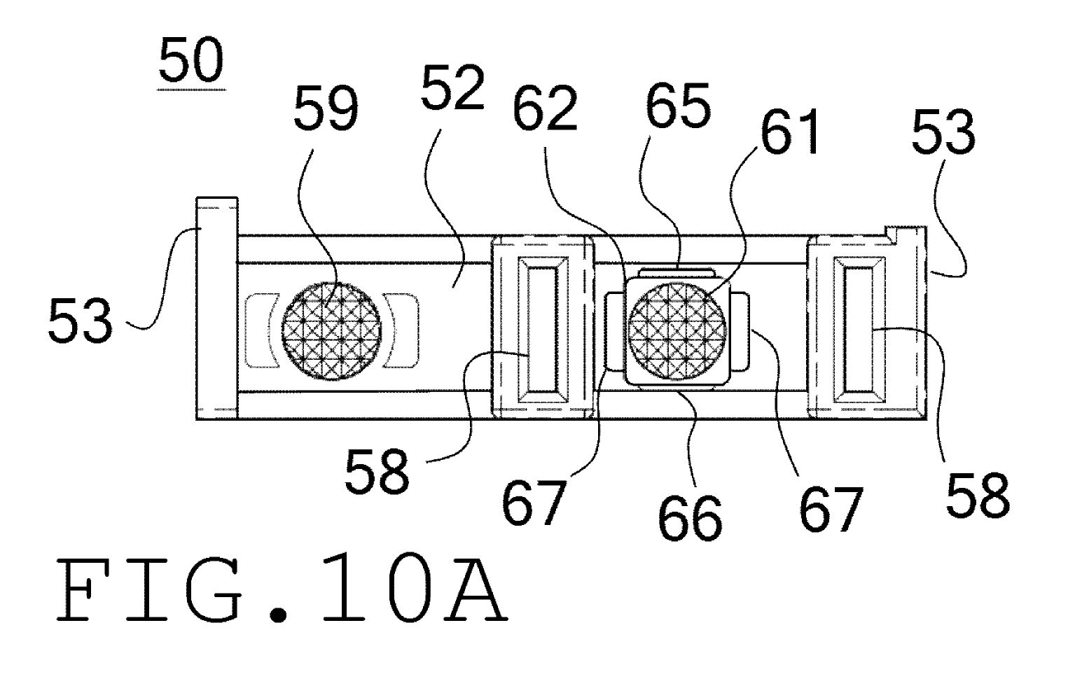

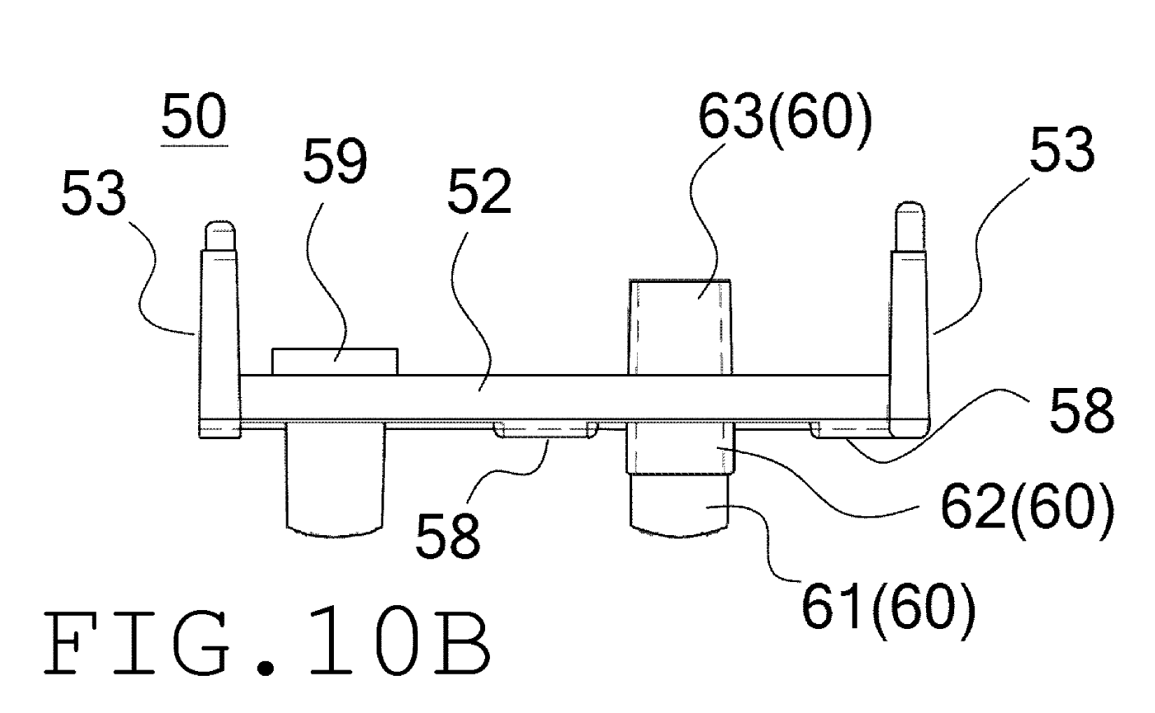

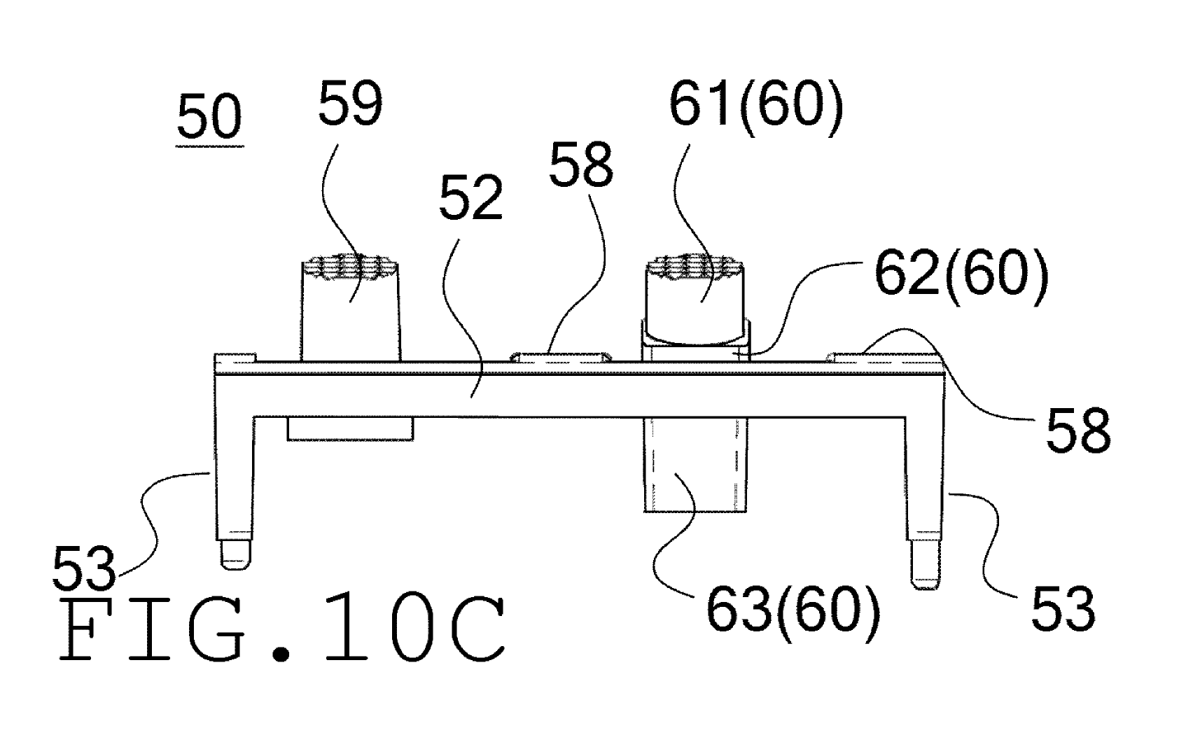

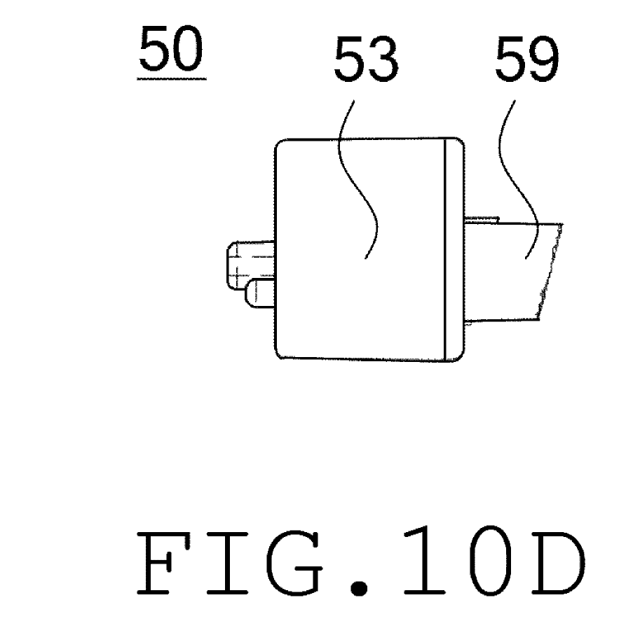

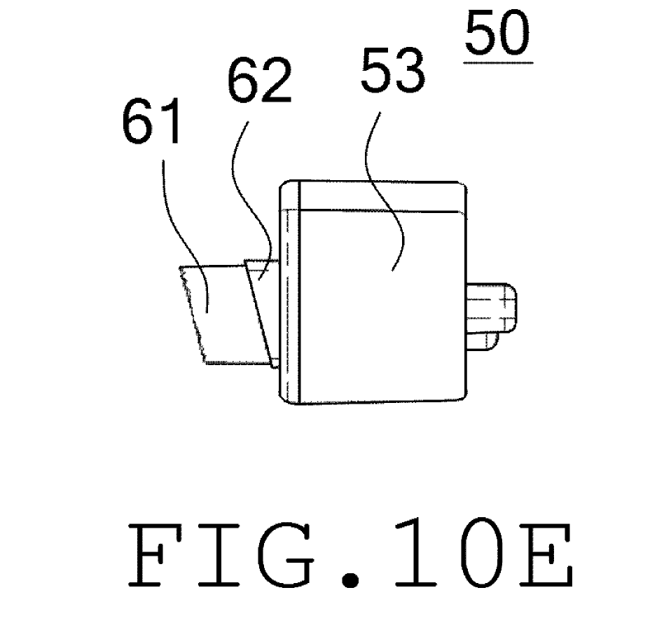

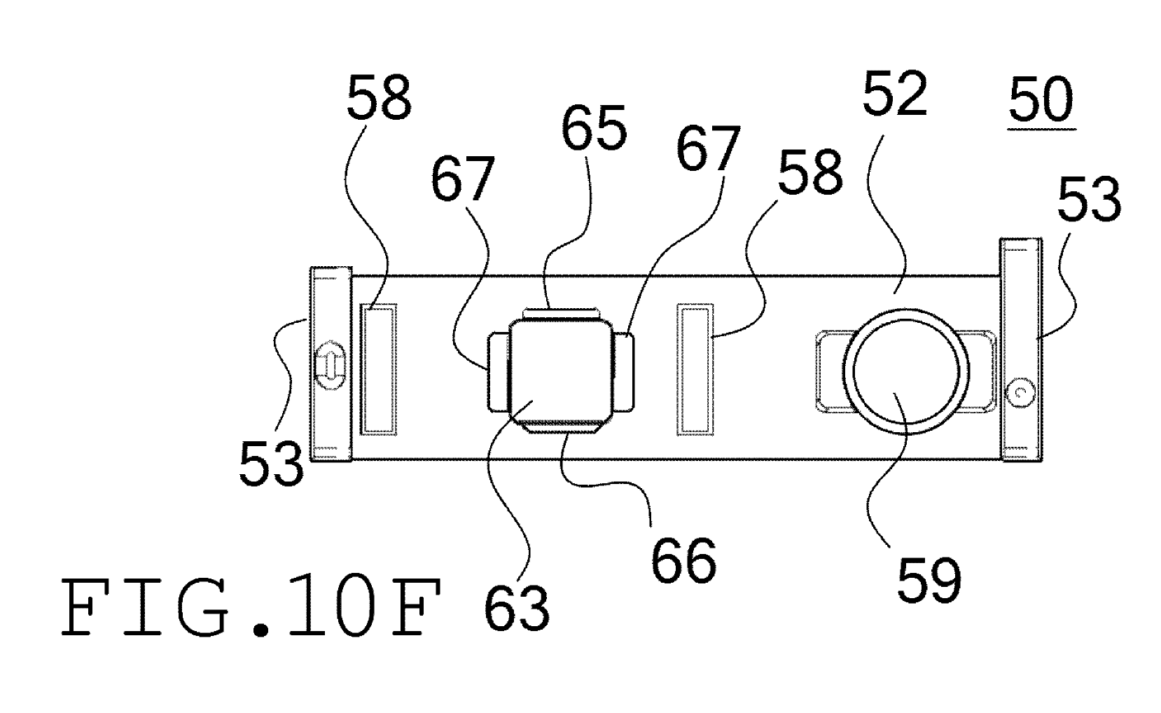

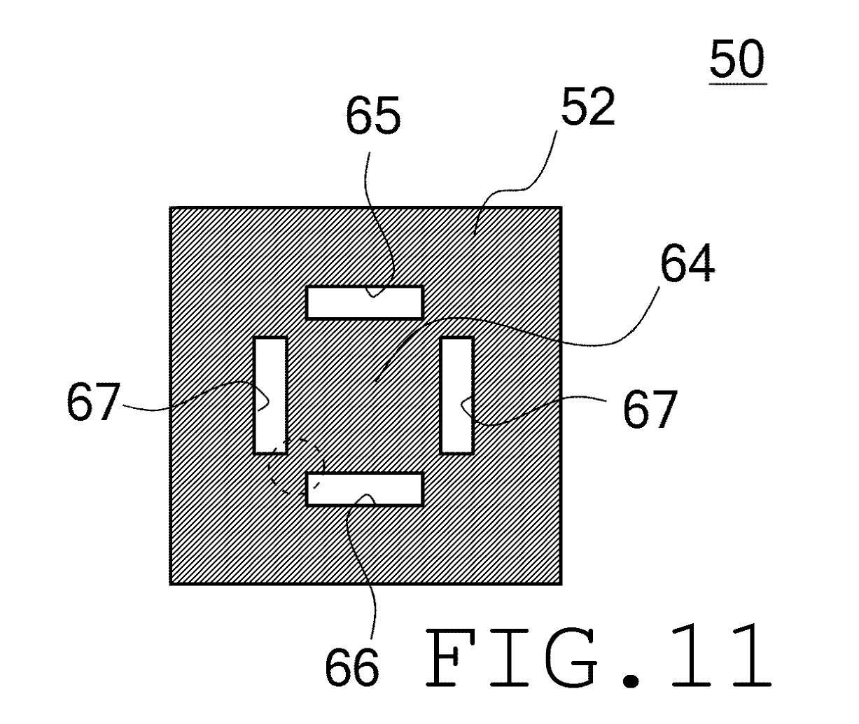

Further, FIG. 10 are views of six sides of the light-guiding member 50, in which FIG. 10A is a front view, FIG. 10B is a plan view (top view), FIG. 10C is a bottom view, FIG. 10D is a left-side view, FIG. 10E is a right-side view, and FIG. 10F is a back view. Furthermore, FIG. 11 is a view showing a cross-sectional shape of the light-guiding member 50.

The light-guiding member 50 is integrally molded from a transparent resin material, and includes a plate-shaped light-guiding member base part 52, a compound light-guiding part 60 that guides light to the illuminance sensor 40, and an infrared light receiving light-guiding part 59 that guides light to an infrared sensor. The infrared light receiving light-guiding part 59 and the compound light-guiding part 60 are arranged on right and left side by side. Side surface parts 53 that extend greatly backward are formed at right and left ends of the light-guiding member base part 52.

The compound light-guiding part 60 is formed on the right side from a center in front view (for example, FIG. 10B).

Moreover, the light-guiding member base part 52 has communication ports 58 that communicate back and forth at a substantially center and in a vicinity of the side surface part 53 on a right side in front view. The communication ports 58 are used for positioning and fixing of the light-guiding member 50.

The compound light-guiding part 60 includes a front square column part 62 that extends forward from the light-guiding member base part 52, a back square column part 63 that extends backward therefrom, and a round column part 61 that extends forward from the front square column part 62. In other words, a square column shape formed by the front square column part 62 and the back square column part 63 has a shape such that the light-guiding member base part 52 is provided as a convex part formed in a convex shape outward from a side surface thereof. Further, a front surface of the round column part 61 serves as an incident surface. This incident surface is provided with a predetermined concave-convex shape in the same manner as a conventional type. In addition, this incident surface is set with inclination so as to be a surface matching with a shape of the ornamental cabinet 18. Moreover, a backward surface of the back square column part 63 serves as an emitting surface.

The front square column part 62 and the back square column part 63 each has a square column shape, and has an upper side and a lower side which are in parallel. Moreover, the upper side and the lower side are horizontal in a state where the compound light-guiding part 60 is attached to the liquid crystal television 10. Here, the square column shape of each of the front square column part 62 and the back square column part 63 has a square cross-sectional surface and a length of one side is set to be substantially the same as or slightly longer than a diameter of the round column part 61. Moreover, the round column part 61, the front square column part 62 and the back square column part 63 are arranged having a same central axis.

Further, as shown in the light-guiding member 150 of FIG. 6B described above, a plurality of slits are formed in the light-guiding member base part 52 such that boundaries of base portions of the front square column part 62 and the back square column part 63 communicate with each other. That is, as shown in FIG. 10 and FIG. 11A, an upper-side slit part 65 is formed in an area in which upper surfaces of the front square column part 62 and the back square column part 63 are connected. In the same manner, a lower-side slit part 66 is formed in an area in which lower surfaces of the front square column part 62 and the back square column part 63 are connected. Further, horizontal slit parts 67 are formed in an area in which side surfaces of the front square column part 62 and the back square column part 63 are connected. As a result thereof, a slit inside area 64 surrounded by the upper-side slit part 65, the lower-side slit part 66 and the horizontal slit parts 67 (refer to FIG. 10A) has a square column shape with a square cross-sectional surface and has a shape as if a square column was formed with the front square column part 62 and the back square column part 63 continued.

Note that, in areas corresponding to corner portions of the front square column part 62 and the back square column part 63, a slit is not formed in order to hold the slit inside area 64 at a desirable position.

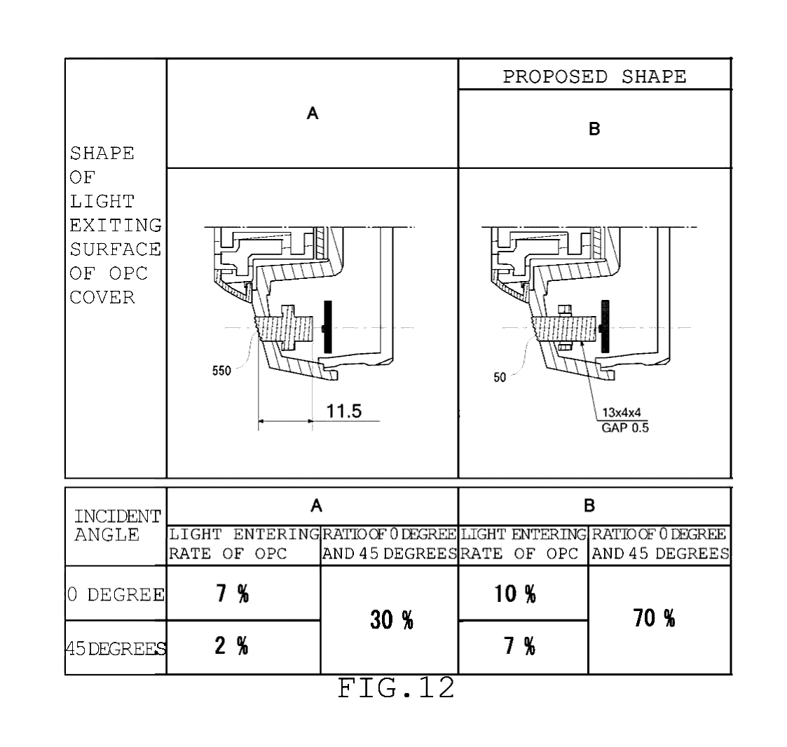

FIG. 12 is a table showing a result of comparison of light propagation characteristics of light-guiding members of a conventional type (shape A; round column shape) and a type of the present embodiment (shape B; square column shape) by simulation. In the conventional type (shape A), a length of a round column light-guiding part is 11.5 mm. Further, a size of a portion of the light-guiding member 50 of the present embodiment, which is substituted with a square column shape, is 13 mm×4 mm×4 mm shown in the shape B.

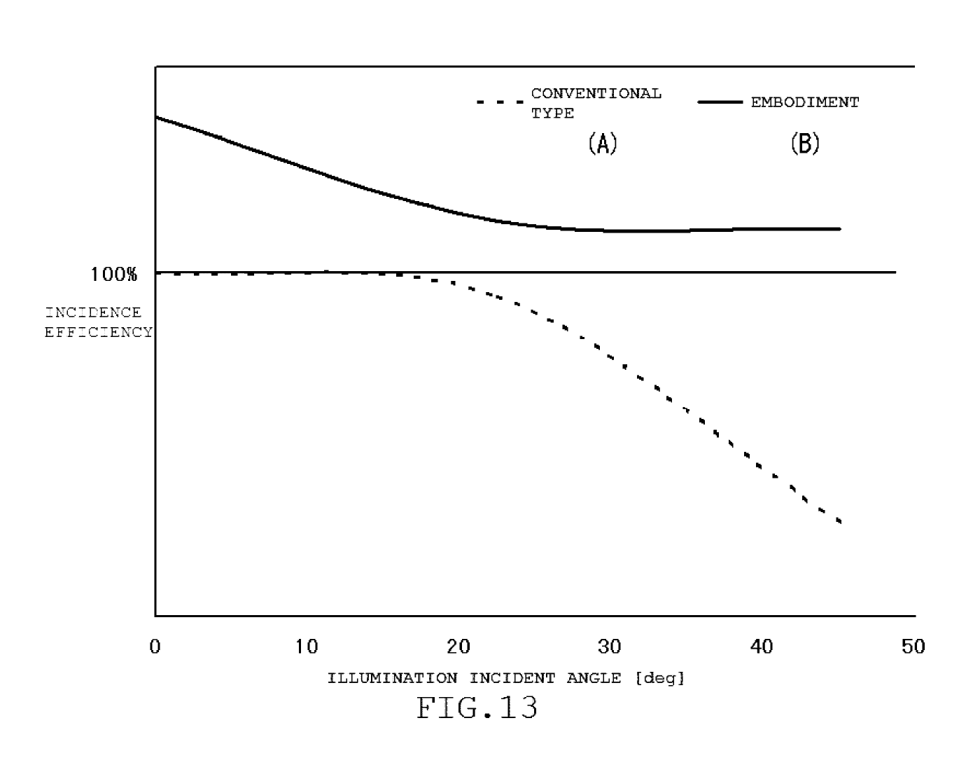

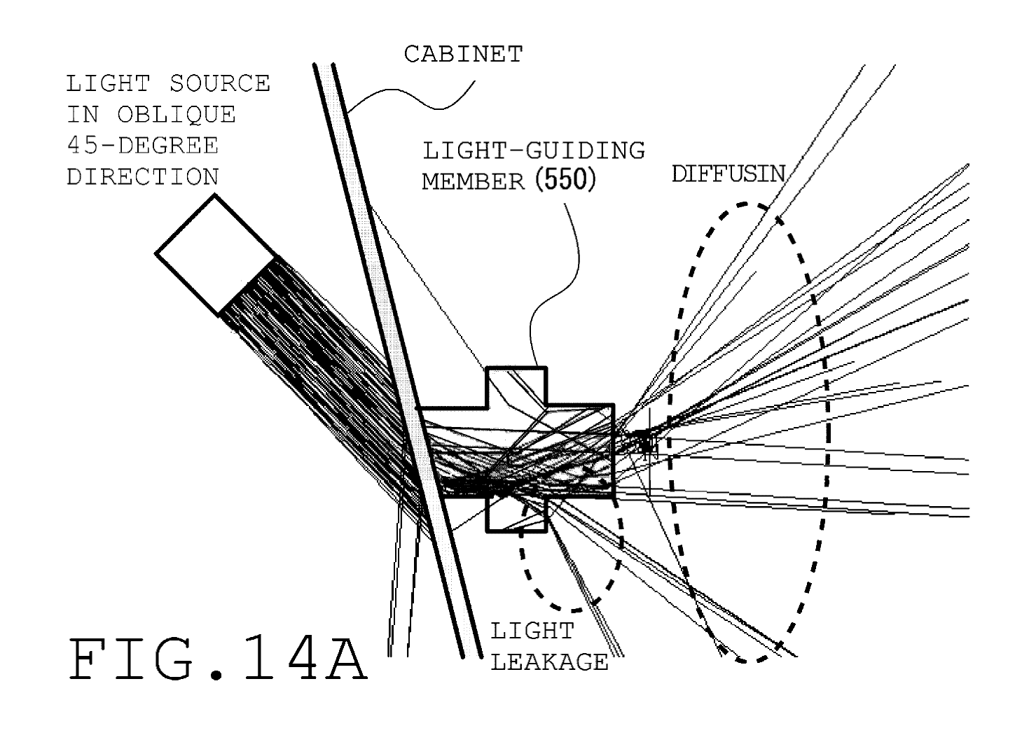

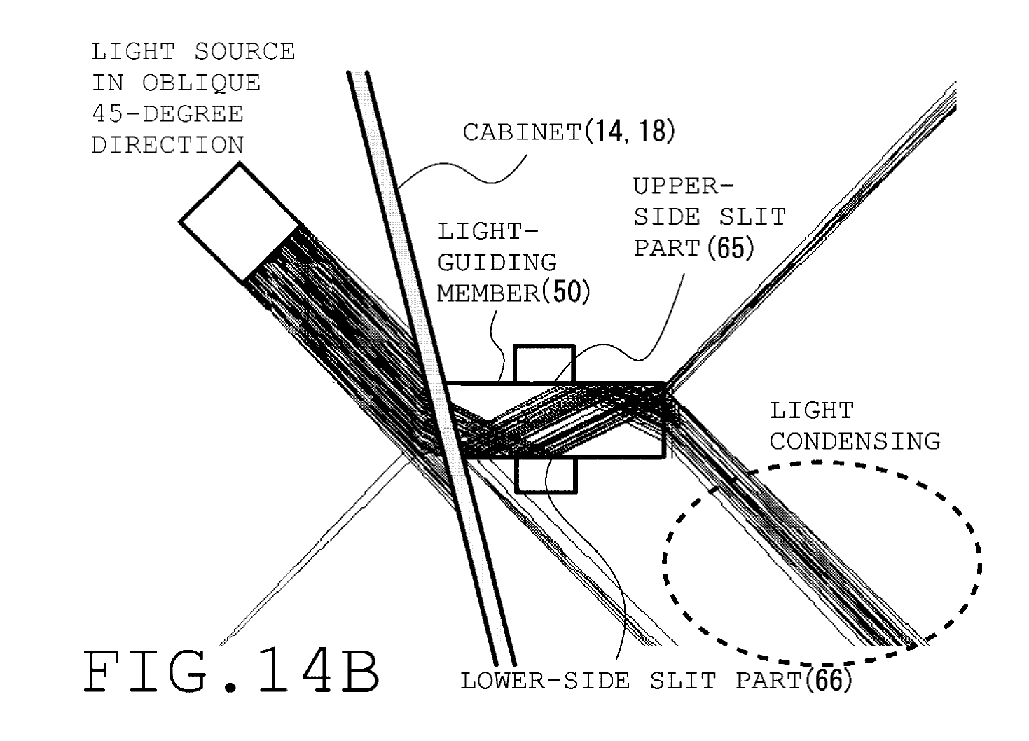

In addition, FIG. 13 is a graph showing characteristics of the conventional type (shape A) and the type of the present embodiment (shape B) as to a result of the simulation of FIG. 12 in a comparable manner. Note that, incidence efficiency in the figure represents a ratio of a light entering rate of a light receiving element in an incident angle of each of the shapes A and B with a value of the light entering rate of the light receiving element when the incident angle of the conventional type (shape A) is 0 degree as a reference (100%). Accordingly, FIG. 13 shows the ratio of the light entering rate of the light receiving element in the incident angle of each of the shapes A and B as a change according to the incident angle graphically. Moreover, the light entering rate refers to a light quantity received by (irradiated to) the light receiving element with respect to a light quantity incident on the light-guiding part. Further, FIG. 14 are views showing light path characteristics of the conventional type (shape A; FIG. 14A) and the type of the present embodiment (shape B; FIG. 14B) shown in the graph of FIG. 13 in a comparable manner. Here, description is only for a light path from a light source in the oblique 45-degree direction.

As shown with the shape A of FIG. 12, in the light-guiding member 550 in the round column shape of the conventional type, the light entering rate for light of oblique 45 degrees to light just from a front (0 degree) in the illuminance sensor 40 (light receiving element 41) is 30%. That is, an intake quantity for the light of which the incident angle is oblique 45 degrees in the light receiving element is about ⅓ to ¼ of an intake quantity in the light receiving element for the light just from the front (0 degree) with a great difference. Further, as shown in FIG. 14A, in the light-guiding part of the conventional type which has the round column shape, emitted light has a diffused state, and it is difficult to improve light condensing efficiency at a desirable position. Moreover, midway light leakage is also increased.

On the other hand, as shown in FIG. 12, in the light-guiding member 50 having the square column shape of the present embodiment, the light entering rate is 70% with the shape B, which shows substantial improvement compared with the light entering rate of the shape A of 30%. As a result thereof, detection accuracy of the illuminance sensor 40 is improved, and screen control using the result is made more appropriate. Further, as shown in FIG. 14B, though the emitted light is divided above and below, it becomes easy to improve light condensing efficiency at a desirable position. Here, it is shown that light is condensed to a lower side than the emitting surface efficiently. Moreover, the midway light leakage is significantly decreased compared with the conventional type. Further, it is possible to mitigate a gap due to an environment. That is, though there is a case where front side and obliquely upward illuminance is different even with same surrounding illuminance of the liquid crystal television 10, it is possible even in such a case to reflect to control of the liquid crystal television 10 (screen control and power saving control) properly.

### Second Embodiment

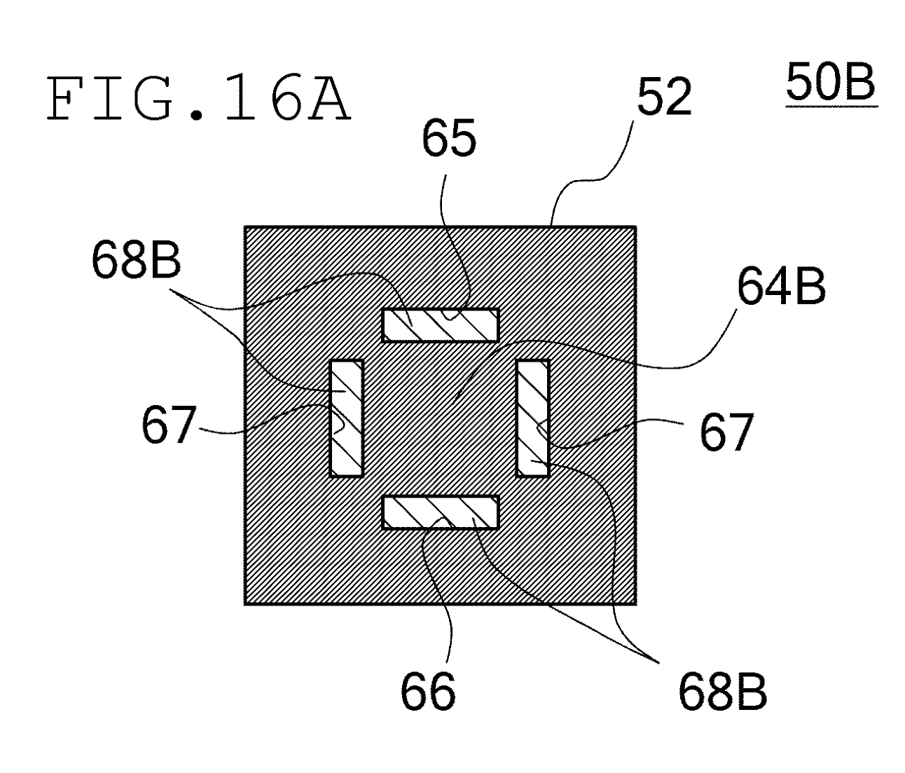

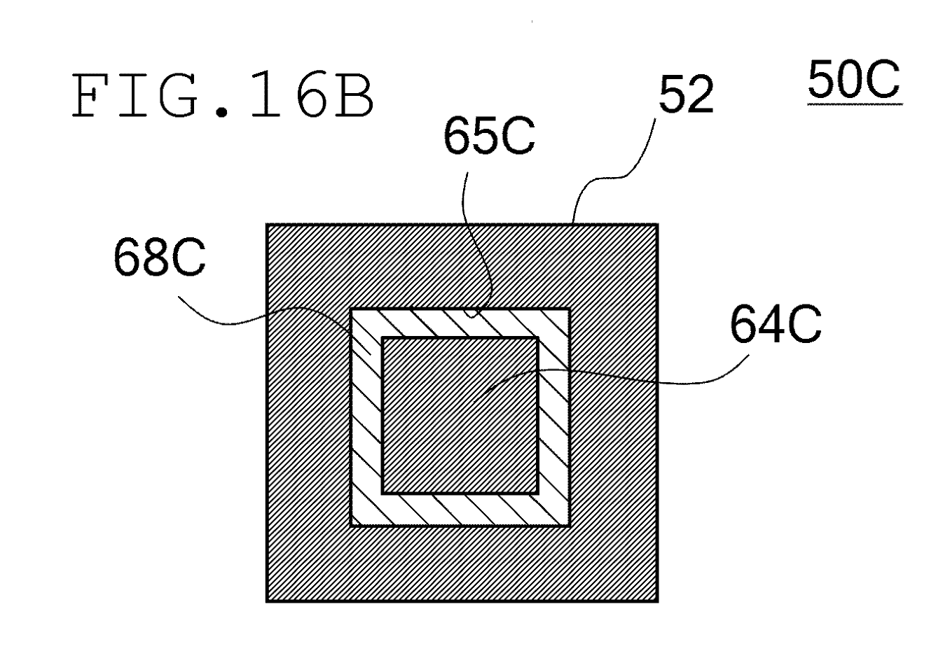

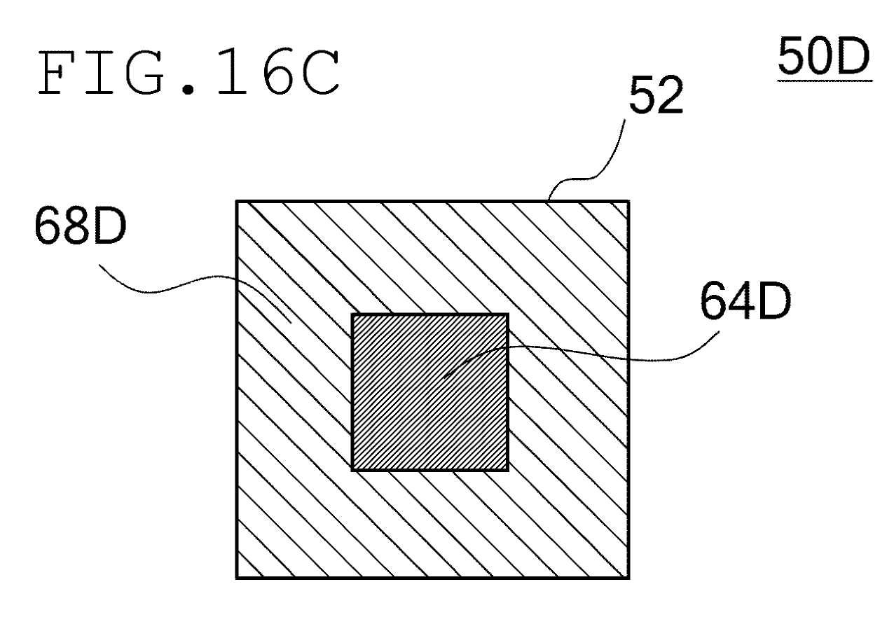

FIG. 16 show cross-sectional shapes of light-guiding members 50B to 50C according to a second embodiment. As shown with a cross-sectional shape of the light-guiding member 50B of FIG. 16A, low refractive index materials 68B having a refractive index smaller than that of a slit inside area 64B may be provided in the upper-side slit part 65, the lower-side slit part 66 and the horizontal slit parts 67, instead of a structure of the light-guiding member 50 of FIG. 11 of the embodiment described above. Further, as shown with a cross-sectional shape of the light-guiding member 50C of FIG. 16B, a low refractive index material 68C may be provided in a predetermined area 65C corresponding to a slit surrounding a slit inside area 64C. When an acrylic resin is used as the transparent resin material of the light-guiding member 50, a fluorine-based resin and a silicon-based resin are usable as the low refractive index materials 68B and 68C. As a molding method, a so-called two-color molding may be used, or a method that a desirable resin material is filled after formation of a slit may be used. By adopting such a configuration, there is no gap (slit) around the slit inside area 64, thus making it possible to improve support intensity. Further, as shown in a cross-sectional shape of a light-guiding member 50D of FIG. 16C, a structure that a light-guiding area 64D corresponding to the slit inside area is surrounded by the low refractive index materials 68D described above may be adopted. As a molding method, two-color molding may be used, or a method for forming a portion corresponding to a support part at the low refractive index material 68D into a predetermined shape and then pressing a structure of the light-guiding area 64D therein may be used. It is possible to support the surroundings without gap and improve support intensity.

### Third Embodiment

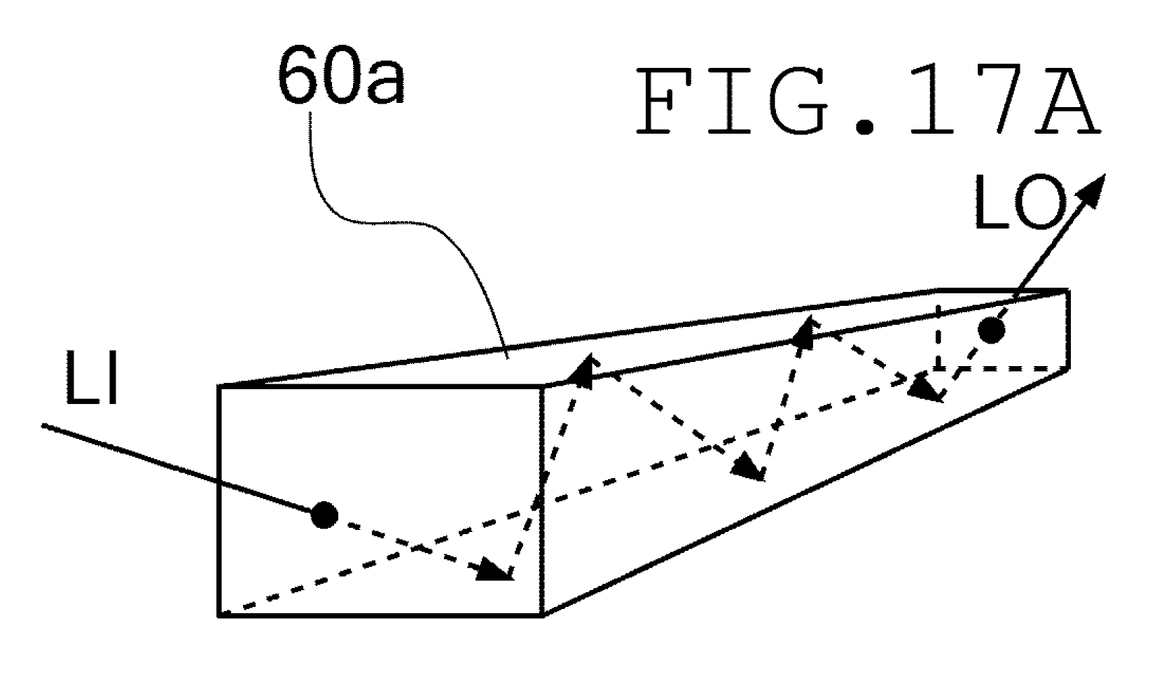

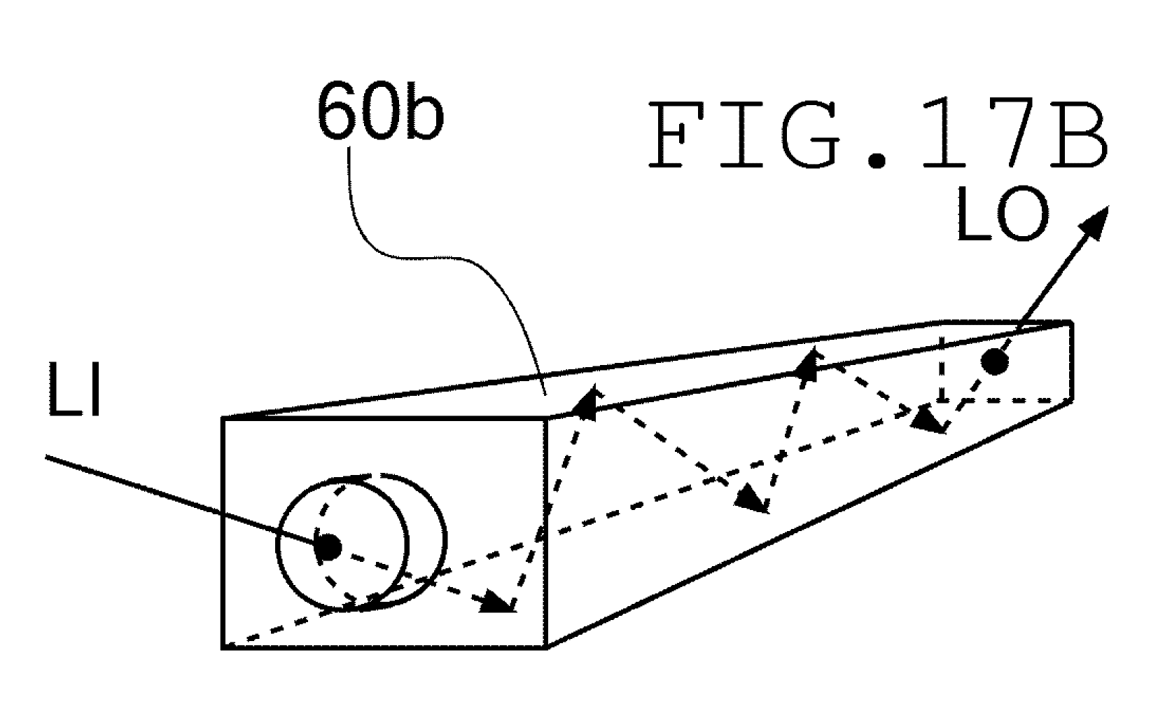

FIG. 17 show a light-guiding part 60a and a compound light-guiding part 60b which have square pyramid shapes according to a third embodiment. As shown in the light-guiding part 60a of FIG. 17A and the compound light-guiding part 60b of FIG. 17B, a light-guiding part which has a column shape with a partially pyramid square shape (truncated pyramid-shape) may be used. In this case, since light density on an emitting surface is increased, the light receiving element 41 is typically small with respect to an illuminating surface, thus making it possible to improve light use efficiency of the light receiving element 41.

### Fourth Embodiment

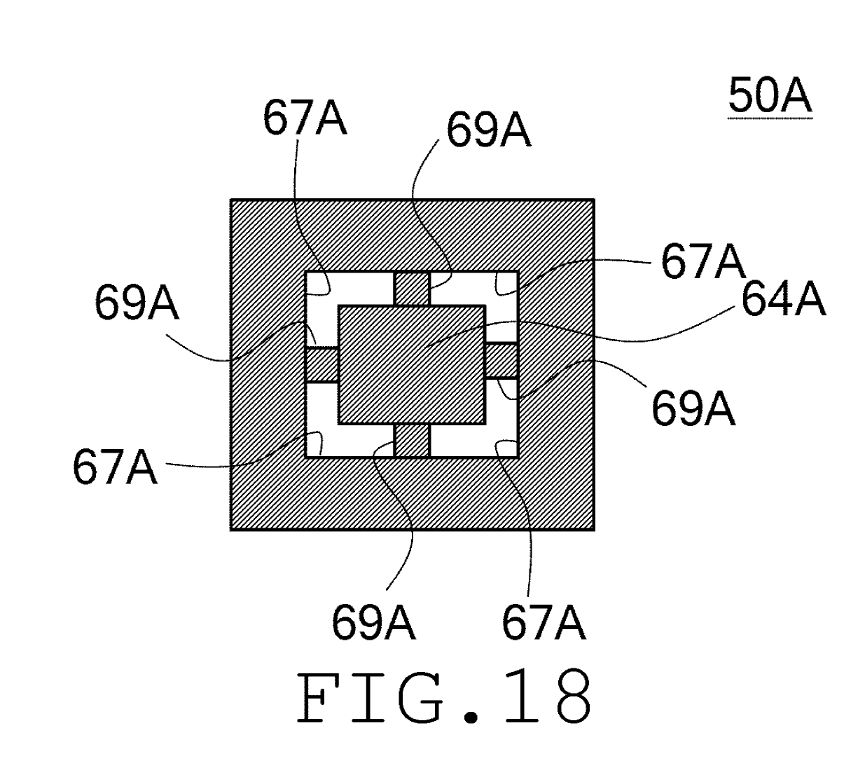

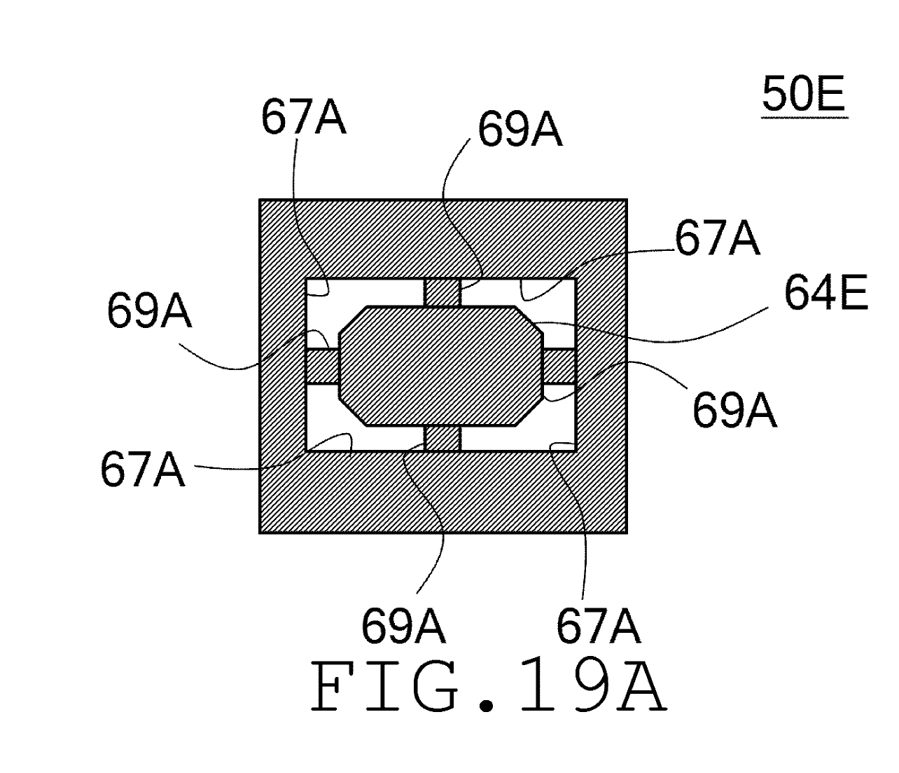

FIG. 18 shows a cross-sectional shape of a light-guiding member 50A according to a fourth embodiment. As to an aspect of formation of a slit, as shown in the light-guiding member 50A of FIG. 18, an L-shaped slit 67A may be formed so that a beam part 69A extends from a center of an outer peripheral surface of a slit inside area 64A.

### Fifth Embodiment

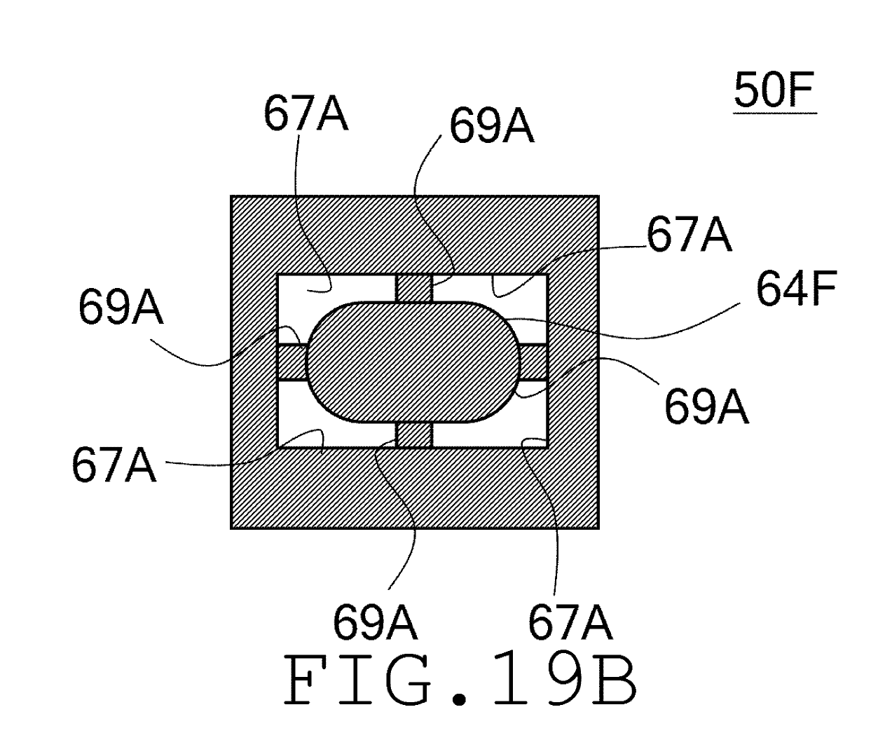

FIG. 19 show cross-sectional shapes of light-guiding members 50E and 50F according to a fifth embodiment. As to light-guiding, since reflection on an upper side and a lower side is particularly important, when an appropriate reflection amount is able to be secured on the upper side and the lower side (upper surface and lower surface), a shape of a side surface portion is able to be set with a certain degree of freedom. For example, the side surface portion may be formed into a convex curved surface. Specifically, as shown in a cross-sectional structure of the light-guiding member 50E of FIG. 19A, a slit inside area 64E may be formed in an octagon shape in front view. Further, as shown in a cross-sectional structure of the light-guiding member 50F of FIG. 19B, a side surface portion of the slit inside area 64F may be formed in a round shape in front view.

As above, the present invention has been described by way of the embodiments. The embodiments are only exemplary and those skilled in the art could understand that, by combining the components thereof, various modifications can be created, and such modifications are within the scope of the present invention.

### REFERENCE SIGNS LIST

10 liquid crystal television
12 display panel
14 front cabinet
15 communication port
16 rear cabinet
18 ornamental cabinet
21 CPU
22 backlight control part
23 backlight driving part
24 backlight
30 illuminance sensor module
40 illuminance sensor
41 light receiving element
42 substrate
50, 50A, 50B, 50C, 50D, 50E, 50F, 250 light-guiding member (light-guiding device)
52, 252 light-guiding member base part
53 side surface part
58 communication port
59 infrared light receiving light-guiding part
60 compound light-guiding part
61, 361 round column part
62, 262 front square column part
63, 263 back square column part
64, 64A, 64E, 64F slit inside area
64D light-guiding area
65 upper-side slit part
66 lower-side slit part
67 horizontal slit part
67A slit
68B, 68C, 68D low refractive index member
69A beam part
150 light-guiding member
152 light-guiding member base part
162 front square column part
162a, 262a incident surface
163 rear square column part
163a emitting surface
165 upper-side slit part
166 lower-side slit part
360 compound light-guiding member
460 square column light-guiding member

1. A light-guiding device that guides light to an illuminance sensor of a display apparatus, comprising
a light-guiding part of a column shape, wherein
one surface of the light-guiding part is a light incident surface on which the light is incident and one surface facing thereto is a light emitting surface from which the light is emitted,
a first side surface which is one of surfaces orthogonal to the light incident surface and a second side surface facing the first side surface are in parallel, and
the first side surface is disposed to be horizontal in a state of being attached to the display apparatus.

2. A light-guiding device that guides light to an illuminance sensor of a display apparatus, comprising
a light-guiding part of a column shape, wherein
one surface of the light-guiding part is a light incident surface on which the light is incident and one surface facing thereto is a light emitting surface from which the light is emitted,
in a first side surface which is one of surfaces orthogonal to the light incident surface and a second side surface facing the first side surface, two straight lines corresponding to the first side surface and the second side surface are in parallel when the light-guiding part is cut along a width direction, and
the straight line corresponding to the first side surface is horizontal in a state of being attached to the display apparatus.

3. The light-guiding device according to claim 1, comprising
a support part that supports the light-guiding part in a lateral direction, and
slits formed on a boundary portion between the support part and the light-guiding part.

4. The light-guiding device according to claim 1, comprising
a light-guiding part support part that supports the light-guiding part in a lateral direction, wherein
a member with a low refractive index than that of the light-guiding part is provided between the light-guiding part support part and the light-guiding part on a surface of the light-guiding part in the lateral direction.

5. The light-guiding device according to claim 1, wherein
an incident part of a round column shape which is formed integrally with the light-guiding part is provided on an incident side of the light-guiding part of the column shape.

6. A display apparatus comprising the light-guiding device according to claim 1, and an illuminance sensor which acquires external light by the light-guiding device.

7. The light-guiding device according to claim 2, comprising
a support part that supports the light-guiding part in a lateral direction, and
slits formed on a boundary portion between the support part and the light-guiding part.

8. The light-guiding device according to claim 2, comprising
a light-guiding part support part that supports the light-guiding part in a lateral direction, wherein
a member with a low refractive index than that of the light-guiding part is provided between the light-guiding part support part and the light-guiding part on a surface of the light-guiding part in the lateral direction.

9. The light-guiding device according to claim 3, comprising
a light-guiding part support part that supports the light-guiding part in a lateral direction, wherein
a member with a low refractive index than that of the light-guiding part is provided between the light-guiding part support part and the light-guiding part on a surface of the light-guiding part in the lateral direction.

10. The light-guiding device according to claim 2, wherein
an incident part of a round column shape which is formed integrally with the light-guiding part is provided on an incident side of the light-guiding part of the column shape.

11. The light-guiding device according to claim 3, wherein
an incident part of a round column shape which is formed integrally with the light-guiding part is provided on an incident side of the light-guiding part of the column shape.

12. The light-guiding device according to claim 4, wherein
an incident part of a round column shape which is formed integrally with the light-guiding part is provided on an incident side of the light-guiding part of the column shape.

13. A display apparatus comprising the light-guiding device according to claim 2, and an illuminance sensor which acquires external light by the light-guiding device.

14. A display apparatus comprising the light-guiding device according to claim 3, and an illuminance sensor which acquires external light by the light-guiding device.

15. A display apparatus comprising the light-guiding device according to claim 4, and an illuminance sensor which acquires external light by the light-guiding device.

16. A display apparatus comprising the light-guiding device according to claim 5, and an illuminance sensor which acquires external light by the light-guiding device.
